(19) United States
(12) Patent Application Publication
(10) Pub. No.: US 2010/0231506 A1
(43) Pub. Date: Sep. 16, 2010

(54) CONTROL OF APPLIANCES, KITCHEN AND HOME

(76) Inventor: Timothy Pryor, Windsor (CA)

Correspondence Address: APPLE C/O MORRISON AND FOERSTER ,LLP;LOS ANGELES, 555 WEST FIFTH STREET SUITE 3500, SUITE 200, LOS ANGELES, CA, 90013-1024, US

(21) Appl. No.: 12/468,401

(22) Filed: May 19, 2009

Related U.S. Application Data
(63) Continuation-in-part of application No. 12/358,404, filed on Jan. 23, 2009.
Application No. 12/358,404 is a continuation-in-part of application No. 11/980,722, filed on Oct. 31, 2007.
Application No. 11/980,722 is a continuation-in-part of application No. 11/980,721, filed on Oct. 31, 2007.
Application No. 11/980,721 is a continuation-in-part of application No. 11/980,710, filed on Oct. 31, 2007, now Pat. No. 7,756,297.
Application No. 11/980,710 is a continuation-in-part of application No. 11/832,134, filed on Aug. 1, 2007.
Application No. 11/832,134 is a continuation-in-part of application No. 11/272,868, filed on Nov. 15, 2005.
Application No. 11/272,868 is a continuation-in-part of application No. 11/045,131, filed on Jan. 31, 2005.
Application No. 11/045,131 is a continuation-in-part of application No. 10/934,762, filed on Sep. 7, 2004.
(60) Provisional application No. 61/054,643, filed on May 20, 2008.

(51) Int. Cl. G09G 5/00; H04N 7/18

(52) U.S. Cl. 345/156; 348/77; 348/E07.085

(57) ABSTRACT

The disclosed invention is generally in the field of control of appliances in the home, and in their networking and connectivity also with audio systems and internet sources and the integration of these elements in a connected manner. Preferred apparatus generally employs a video projection system and one or more TV cameras. Embodiments of the invention may be used to enhance the social interaction and enjoyment of persons in the kitchen and reduce the work of food preparation. The invention may be used in many rooms of the house, and contribute to the well being of seniors and others living therein.

### CROSS REFERENCE TO RELATED APPLICATIONS

This application claims benefit of U.S. Provisional application 61/054,643. Meal Preparation and Appliance Control filed on May 20, 2008.

The application herein is a continuation in part of my co pending application Ser. No. 12/358,404 filed on Jan. 23, 2009; Ser. No. 11/980,722 filed on Oct. 31, 2007; Ser. No. 11/980,721 filed on Oct. 31, 2007; Ser. No. 11/980,710 filed on Oct. 31, 2007; Ser. No. 11/832,134 filed on Aug. 1, 2007; Ser. No. 11/272,868 filed on Nov. 15, 2005; Ser. No. 11/045,131 filed on Jan. 31, 2005; and Ser. No. 10/934,762 filed on Sep. 7, 2004, the disclosures of which are incorporated by reference herein.

The application herein related to further of my co pending application Ser. No. 11/980,718 filed on Oct. 31, 2007; Ser. No. 11/980,715 filed on Oct. 31, 2007; Ser. No. 11/852,690 filed on Sep. 10, 2007; Ser. No. 11/495,666 filed on Jul. 31, 2006; Ser. No. 11/439,442 filed on May 24, 2006; Ser. No. 11/376,158 filed on Mar. 16, 2006; Ser. No. 11/371,224 filed on Mar. 9, 2006; Ser. No. 11/349,350 filed on Feb. 8, 2006; Ser. No. 11/319,807 filed on Dec. 29, 2005; Ser. No. 11/272,868 filed on Nov. 15, 2005; Ser. No. 11/186,898 filed on Jul. 22, 2005; and Ser. No. 10/893,534 filed on Jul. 19, 2004, the disclosures of which are incorporated by reference herein.

### FIELD OF THE INVENTION

The disclosed invention is generally in the field of control of appliances in the home, and in their networking and connectivity also with audio systems and internet sources and the integration of these elements in a connected manner. Preferred apparatus generally employs a video projection system and one or more TV cameras. Embodiments of the invention may be used to enhance the social interaction and enjoyment of persons in the kitchen and reduce the work of food preparation. The invention may be used in many rooms of the house, and contribute to the well being of seniors and others living therein.

### BACKGROUND OF THE INVENTION

There has been substantial discussion of home automation, “the Digital Home” and related topics in the literature, particularly regarding entertainment systems (e.g. TVs, Games, Audio systems) which may be networked together, little has appeared commercially. In some cases, features which companies have added to differentiate their products, have actually made the appliance more difficult to use The difficulty of use issue has been discussed in my related co-pending applications particularly in a vehicle context, but many similarities exist here. For example, the need to be operable by a wide spectrum of users. Another example is the stress and distraction situation that sometimes exists in the home, particularly in the kitchen.

In addition, many homes have a single working parent, or both parents working and there is a need to help people in the kitchen cook new and healthy but unfamiliar recipes in a timely manner without error and in a manner that reduces stress. There is an associated need therefore to be able to easily make measurements of volume of liquids or granular materials, weight, area or dimension and other variables incorporate the required amounts into recipes.

I believe there is a need to provide new methods and apparatus in the kitchen which can allow the effective control of services in the home from this central location, where a great deal of the home activity occurs. And there is a need to reduce unnecessary repetitive labor in the kitchen. There is also a need in the kitchen to get the maximal value from space, especially in certain countries where counter space is limited.

There exists also a need for devices, which can improve safety of operation of home systems, particularly ovens and ranges. And for new methods to insure the general well being of seniors and disabled persons living at home. For those who are sight impaired or under stress, there is also a need for easier to see, easier to operate and less distracting controls

### SUMMARY OF THE INVENTION

The invention is related to several of my co-pending applications and previous patents which describe a new form of RTD control surface aimed at answering the needs above, and in providing a plethora of new added features which can ease kitchen and house work, while allowing the user to share time for home functions with internet shopping, social networking and the like.

The invention contains many novel methods and apparatus, included in numerous embodiments. In one preferred rear projection embodiment, a large screen that is generally rear projection based and while generally flat is situated on the top of a counter (e.g. a kitchen counter) or appliance. Portions of the screen may be curved, for example up the backsplash region of a countertop or range. And like my many vehicle embodiments in other copending cases, the screen can be of irregular shape, to wrap around fixed items such as range burners, gas control knobs, faucets, or other items of common utility in the home. The screen can desirably also be removed for cleaning, which is particularly helpful if the screen surface contains indentations or relief elements or other shapes as tactile references, which could trap debris.

The invention preferably uses machine vision to see the position of various control elements such as knobs or sliders or switches. Such machine vision processing of camera images or other electro-optically acquired signals further can see the actions of a user, both their hands and fingers, but also their actions in terms of performing tasks, like rolling dough, cutting a steak and the like. The invention also optionally can employ machine vision or other electro-optical techniques to determine weights and measures, greatly aiding and simplifying the work in the kitchen.

Machine vision sensing, coupled with suitable computer software, can also, as disclosed in my referenced applications, determine gesture commands in space made by a person, and can determine various features of the person or objects they are working with, or in some cases their movements and action. Many other machine vision related features of the invention will be disclosed in the following embodiments as well.

In one embodiment of the invention, the camera and machine vision system acts to assure safety of range top operation, and to enable a stirring robot or other device to be safely controlled. The invention, especially in rear projection form, allows for dramatic style. Any shape, and any patterns or colors projected to your desire on the work surface screen. Interchangeable shapes and function may be employed as well. The screen and control surface can be incorporated not only in counter, but in the tops of washers, dryers and ranges. One can with the work surface/ screen, curve it for example to sweep it up at the sides or back etc. The surface can be located near water or heat, since with projection based versions of the invention, the projection and sensing electronic components are relatively speaking, remotely located. As I have noted in previous applications and herein, this allows them to be placed in bathroom locations, on range tops and the like.

A fundamental concept further disclosed herein relates to kitchen located apparatus serving as the control center for the home and its appliances. The invention may be a counter top located display or as also disclosed, a display projected onto a counter, a top of an appliance, or vertical surface such as might be on a fridge door. It may be a control centre of multiple appliances and functions and/or as a standalone unit used for information, home networking/automation, connectivity and food preparation. The invention allows the reconfiguring of controls and other novel features not known to exist elsewhere, while at the same time becoming increasingly affordable.

Key features such as reconfigurable intuitive and tactile controls or virtual simulated real controls such as knobs or switches, individually or in combination,—can be used for controlling all appliances in home, further including HVAC, sound system etc. Accordingly the learning curve is reduced or eliminated, since one can even map existing appliance control layouts onto screen—economically and effectively customizing the system for a single users situation! In addition, if such techniques become employed in vehicles, as is hoped, there exists a chance to have common man-machine control systems between home and car.

The optional and unique food preparation center aspect of the invention can optionally incorporate water or cooking services. The food preparation work surface also serves as a projection screen, on which items can be sensed such as the person's hands and fingers thereon. Unique measuring and instructional capabilities are also available such as liquid levels, areas, volumes, cutting instructions, and weight. These measurements can be automatically taken and registered in any units in any language in conjunction with for example recipes loaded off the net.

This device may supplement/replace a conventional range top and/or sink. In one version, you can “cook on the screen” so to speak. The water services aspect allows one to extend the reach of the device into sinks, bathrooms and laundry tubs for example. And the unit can also act as a computerized desk for writing or leaving notes, arranging photos, and the like. The invention can act as an entertainment system as TV images and sound can be shown on the island, counter or other location, as can internet sites, photo albums and other things too.

A working mother, using the invention for example, can perform common internet chores such as shopping, while stirring something on the range, which operation may also be automated using the invention. The screen and the range top may indeed coexist. In addition she does not have to search for measuring cups and spoons as its all done by the device in an optional configuration. Nor does she have to convert units. In all, a real time saver, if the goal is to cook good healthy meals.

The invention is also a control system for appliances, HVAC, and electronic systems in the home, and maybe other places such as factories, small shops etc. when appropriately configured. Basic to the preferred embodiments is a projector/sensor module of about 150 lumens which projects text or graphics on, and optionally using sensory capability, senses activity on, the top or front of a refrigerator (also herein called a fridge), dishwasher, range, washer or dryer. It would be sold with the surface and optical components as needed. And in another form, can do the same for a desk or table. Some applications may be able to use low power/low cost projectors slated for cell phones (e.g. 15-35 lumens). And even may use a computer based smart cell phone (with or without such a projector) to control the appliance or system itself

The projector/sensor module is used in conjunction with a computer which drives the graphics, interprets the inputs, and connects to I/O as desired. It also is used to perform measurements of food using machine vision, and connects with the internet and other data and communication utilities.

An embodiment of the invention employs a substantially life size screen projection, typically front projected to save space, and can further provide machine vision based means to interact with the projected images displayed. 2D cameras like webcams, and/or 3D cameras such as that of Canesta Corporation can be employed as input to such machine vision processing. The means of interaction can be using a person's hands head or other body parts, or may be via things the person is working with in performing activity in the kitchen. In one embodiment the machine vision may be used to further determine movements, actions, identity or other characteristics of the person or persons in the kitchen. While such may be used in other rooms as well, as appropriate, the kitchen is thought to be the main place where such interactivity maybe desired.

Some versions of the invention utilize rear projection, while others use front projection to display images. It is also possible in some cases to use more conventional flat panel displays such as LCD or OLED displays, as also taught in co-pending applications.

It is a goal of the invention to measure and assist and inform, for example to provide diet advice to the user, including calculations made of calorie content from material measured on the combination screen and work surface. In addition it is a goal to provide cooking or other preparation advice from a data storage (local or internet), including where feasible automatic transfer of such info to a cooking operation (such as baking, for example).

It is also a goal to provide forming or cutting advice from material extent determined, which can be used to calculate approximate measures.

It is another goal of the invention to provide a method and apparatus for control of a plurality of appliances in the home or other location from a common control panel in which virtual controls simulating actual controls of individual devices are provided.

It is also a goal of the invention to provide a novel system for aiding seniors, partially blind persons, and other disabled persons generally in their home, in addition to the primary focus activity in the kitchen.

It is a goal of the invention to provide easy to clean display and work surface.

It is a further goal of the invention to disclose methods and apparatus for reducing appliance cost and improving their human interface.

It is a goal of the invention to improve the safety of operation of kitchen equipment and other apparatus in the home.

It is a goal of the invention to enhance the social aspects of cooking and kitchen activity, and other activities. The invention combines food preparation space with display, measurement, and interaction space, and providing control functions as well, all in a fun to use and helpful way.

It is a further goal of the invention to provide free space gesture methods for control of images and other functions.

It is a goal of the invention to safely provide robotic operation of certain food preparation chores.

Further features and advantages of the present invention will be set forth in, or apparent from, the detailed description of preferred embodiments thereof which follows.

### BRIEF DESCRIPTION OF THE DRAWINGS

FIG. 1a illustrates in side view an island or peninsula located counter top embodiment of the invention, including a washable, replaceable and interchangeable work-board and display surface operating in conjunction with a control system.

FIG. 1b illustrates a perspective view of one version of an island having added features such as an integrated sink and range burners.

FIG. 1c illustrates a work board having a partially curved surface, projected keyboard, relief features at one or more desired locations, and internet display to allow shopping on line while cooking or performing other activity.

FIG. 1d illustrates use of the work board as a cutting board.

FIG. 2a illustrates reconfigurable control and display features of the invention employing common, intuitive physical control details.

FIG. 2b illustrates a virtual mapped control panel of an external audio system whose operation utilizes rotation, pinch and other touch commands.

FIG. 2c illustrates a virtual control panel for heating and air conditioning services.

FIG. 3 illustrates a LCD sensing display with a protective cover forming a work surface.

FIG. 4a illustrates projection of information and sensing from above the work surface.

FIG. 4b is an additional overhead embodiment.

FIG. 5a illustrates an appliance control panel embodiment.

FIG. 5b illustrates an alternative display and control surface.

FIG. 6a illustrates a low cost control embodiment.

FIG. 6b illustrates a one method of providing illuminated control labels with an apparatus of FIG. 6a.

FIG. 6c illustrates reconfiguration of combined washer and dryer display and controls employing a small projector at an oblique angle.

FIG. 7a illustrates an embodiment of the invention useful for measuring liquid level in containers and guiding the user.

FIG. 7b illustrates an alternative embodiment of the invention useful for measuring liquid level in containers.

FIG. 8 illustrates level measurement from above or below a screen and work surface using a special container with sloping sidewalls.

FIGS. 9a-b illustrate a work-board with direct weighing capability.

FIG. 10 illustrates a bathroom sink of the invention.

FIG. 11 illustrates a flip down cubicle desk embodiment of the invention also illustrating a wall mounted control surface like that of FIG. 2.

FIG. 12a illustrates finger gesture inputs of use with the invention.

FIG. 12b illustrates a display of a house plan and status.

FIG. 12c shows a person using their right forefinger to touch a virtual graphic of an oven.

FIG. 13 illustrates an embodiment to aid safe living at home by monitoring movement, location and medicine regimens.

FIG. 14 illustrates an embodiment of the invention using one or more cameras in a range hood for range control functions and robot control.

FIG. 15 illustrates a version of FIG. 2a in which a screen image of a cell phone is mapped directly on to work and the phone and its functions controlled directly by touching the work surface or manipulating controls.

FIG. 16 further illustrates sensing techniques associated with the apparatus of FIG. 14.

FIG. 17a illustrates a rear projection embodiment arrangement for stove control, and internet connection.

FIG. 18a is a front projection embodiment including sensing of characteristics or actions of the person or persons in the kitchen.

FIG. 18b is a front view facing the fridge.

FIG. 18c is another fridge embodiment but with the screen on the main door of a bottom freezer type fridge allowing a quasi-full length substantially lifelike image to be displayed on the fridge door.

FIG. 19 illustrates an embodiment employing a front projection display behind a sink in the kitchen, bath, laundry or other location at which a person may be working.

FIG. 20 illustrates a microwave mounted projection to a screen on the rear of a range, having a curved lower section at the bottom.

FIG. 21 is a diagram of networked appliances and other peripheral interfaces in which software in the main control (in this case located in a kitchen counter) not only interfaces to the appliances, but controls details of their operation.

FIG. 22 illustrates liquid or material exchange determination by monitoring of dynamic pouring.

FIG. 23 illustrates a projector based automobile center stack or appliance control panel of the invention with conventional knobs and switches.

FIG. 24 is an alternative automotive center stack arrangement to that shown FIG. 23.

### DESCRIPTION OF THE PREFERRED EMBODIMENTS

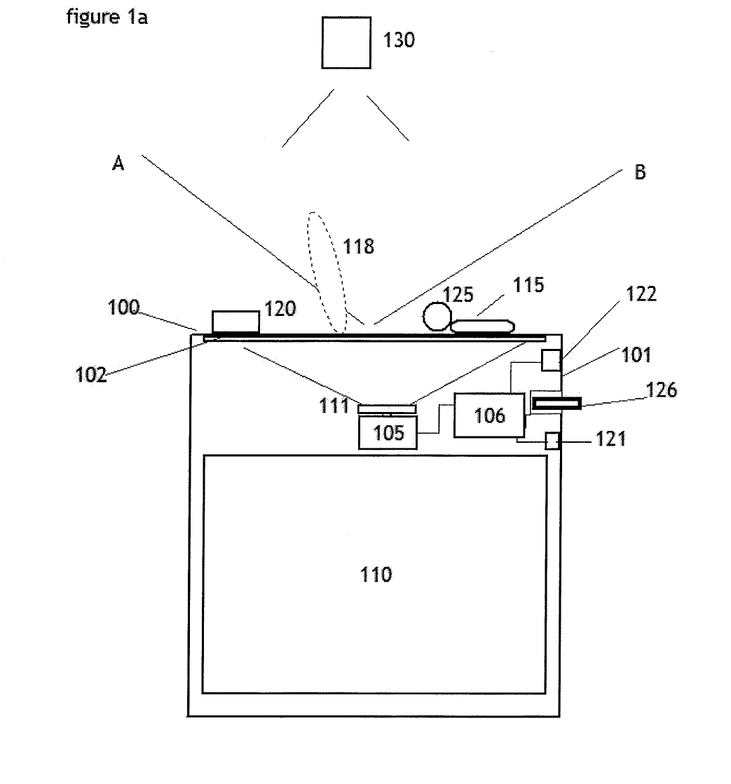

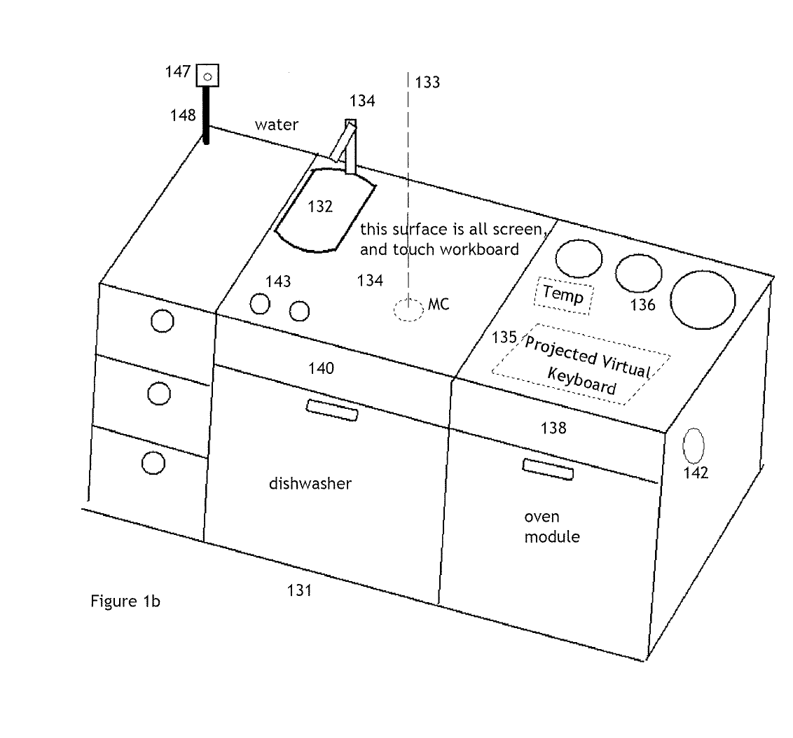

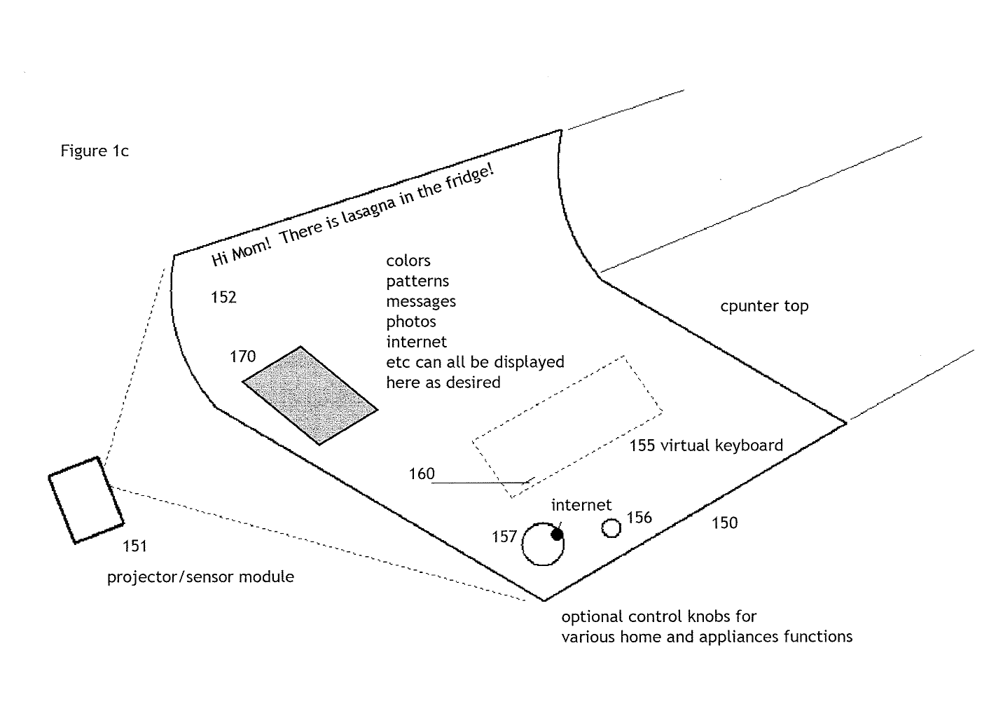

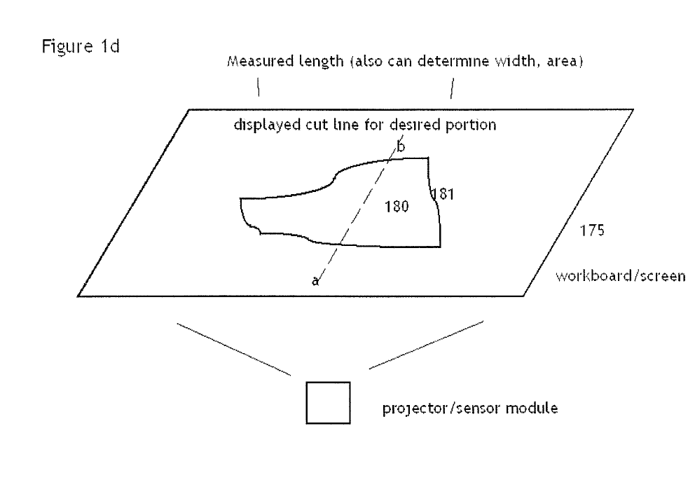

FIG. 1a illustrates an island located counter top embodiment of the invention, including a washable work-board and display surface, in which persons hands or fingers, or work objects placed on the surface are electro-optically sensed, in addition to sensing. Also illustrated is the sensing of physical control details such as knobs and switches which may also be desired for control or other purposes.

FIG. 1a herein in side view illustrates a kitchen counter of the invention 100, in this case in an island of the kitchen 101 having unique abilities to aid food preparation. The invention uses the RTD device shown in many of my co pending applications and patents and uses a TV camera or other electro-optical sensor and projector combination 105 (controlled by computer 106) to project onto a screen such as 102 forming a portion of the counter, and to sense, for example a persons hands or fingers or work objects or food or other materials on the screen surface 102, which also may form a work board on which kitchen work can be done as will be disclosed. All arrangements with cameras, led's, projectors etc. disclosed in my previous application can be used. Space 110 serves to illustrate where drawers or a dishwasher or a oven might optionally be placed in the counter.

To maximize the image viewed by persons standing next to the counter, a Fresnel lens or prismatic screen arrangements may be used to aid in direction of light toward these persons. More light can be directed, if the person is only standing on one side of the counter, which is often the case if the counter is up against a wall.

Also illustrated is the sensing of physical control details such as knob 120 which may also be desired for control or other purposes, for example to control the temperature or time of a range nearby which is interconnected by a network to the computer 106 processing the camera image or other optically sensed data from the screen and work surface.

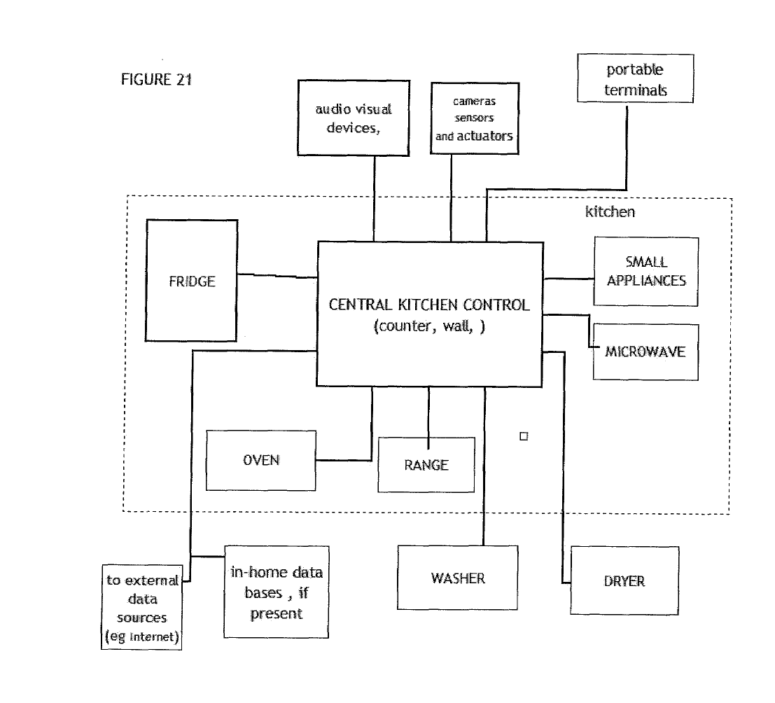

The computer 106 further drives a projector included in 105 or other video image display device, to display images on the work-board surface, in this case from the rear. This board may if desired be situated in the top portion of a dishwasher, either freestanding or inserted into the counter with the work-board surface typically but not necessarily flush with the counter top. A microphone 121 and a loudspeaker 122 are also provided to enable communication from and to the computer. A connection wireless or wired to other appliances and services in the home, and/or to the internet is often desirable as well. (see FIG. 21)

As has been disclosed in co pending applications, a finger such as 118 of the user, or other body parts such as other fingers or a hand can be sensed by the camera or other electro-optical sensor of the invention. In this manner input commands and actions can also be entered to the computer 106.

Also as discussed in previous applications, the work surface can be made of a material, which is transmissive to the projector image and to the camera (or other electro optical sensing means utilized) such that finger locations hand locations and objects such as the pile of cookie or pizza dough or some other object (including the knob 120 or other physical control detail) can be sensed and illuminated if desired. The work board surface can be removable for cleaning a major feature of the invention. And it can be replaced in case of damage due to cutting on it or the like. Since all of the optical and sensing and computing equipment is down below and can be protected by a suitable window such as 111. When not being used for cooking purposes, the work surface can be used as a screen to display TV images of popular shows or data pulled from the Internet on interesting recipes or other desired information.

The computer is typically connected to the internet by known means including wirelessly, and can be used to display information from the net on the work-board, which in the case shown is suitably transparent to allow such information to be visible to the user and perhaps others also in the kitchen. The computer can also transmit video or sensed information obtained using the camera or inputted via the microphone. Such internet connection also facilitates the use of the invention as a means of social networking with respect to family members, friends, and other information sources who would like to be part of one's food preparation experience.

An object on the work board, such as a dough pile 115 can be measured in its extent X and Y in the plane of the work board using the sensor included in 105, such as a TV camera, and a suitable machine vision program such as Matrox imaging library resident in computer 106. This data for certain materials can be used to approximate volume, as the material typically lays in a typical mound height when a certain extent in the horizontal direction. The program in computer 106 instructs the user how to make the mound, in one example, by projecting an image of the mound extent and shape desired onto the screen of the work-board.

The electro-optical sensor of the invention can also see some tools used to work material on the work board. For example a rolling pin 125 used to roll dough pile 115, can be monitored for how far it moves (rolls) and how many repetitions are made. The same device can see other working objects such as meat tenderizing hammers for example. Signals can be generated when a number of repetitions have been arrived at, or other such information.

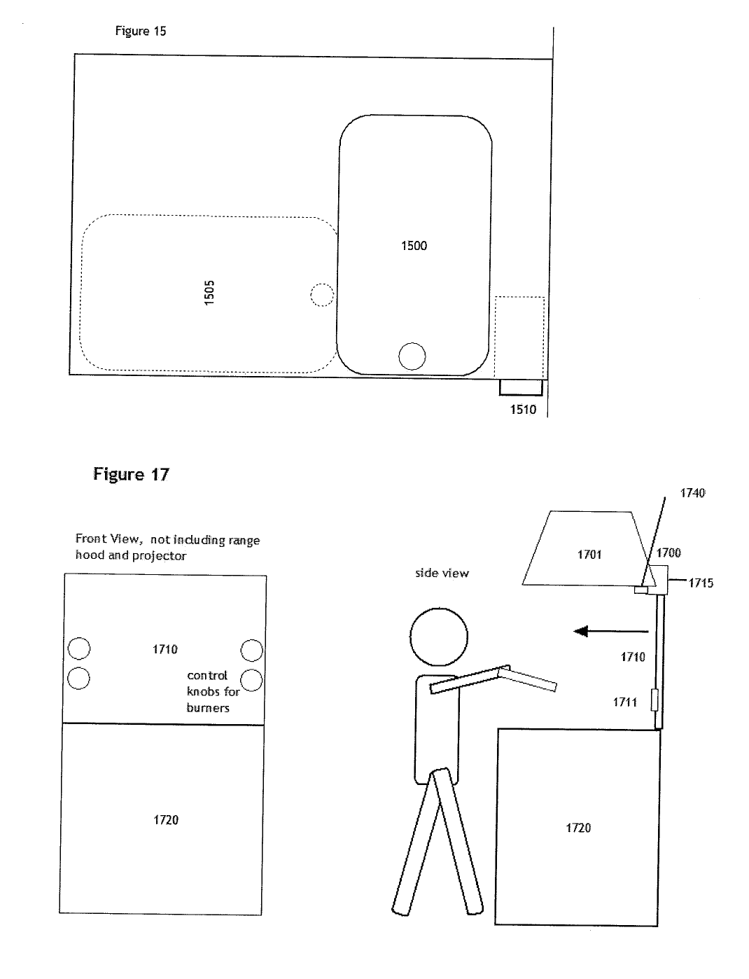

Alternative to the apparatus just shown the projector and/or camera can be mounted overhead. This is the most flexible arrangement as little depth into the counter is needed. In one example, an LCD or other flat panel display can be used for the work board (preferably with a protective cover glass) and an apparatus 130 having a camera overhead used to obtain information from the work board region. In another example, a combined sensor/projection module 130 may be used (similar to ones I have shown in copending applications such as Ser. No. 11/980,722) with a work board of ordinary materials chosen for good diffuse reflectance characteristics for the projected video image information. Apparatus 130 can be unobtrusively located for example on a light track connected to the ceiling, receiving power from the track and for example, wirelessly transmitting data to and from a remotely located computer. This version will be discussed below as there are different measuring methods available and issues to contend with such as hands or other body parts getting in the way. There is however another opportunity of using hand gestures in space to control in whole or in part the system. For example, such a hand gesture might be waiting ones hand over the item to be described in a displayed recipe presentation in this case for example waving ones hand over pizza dough 115. It should be noted that a cell phone 126 of the user can be used to input data to the computer 106, also to allow the information in the cell phone to be displayed as shown in FIG. 15, or for other purposes. The screen surface can be used as well to input calling instructions to the cell phone, for example from a displayed listing of phone numbers. The cell phone can be conveniently charged while connected to the home current.

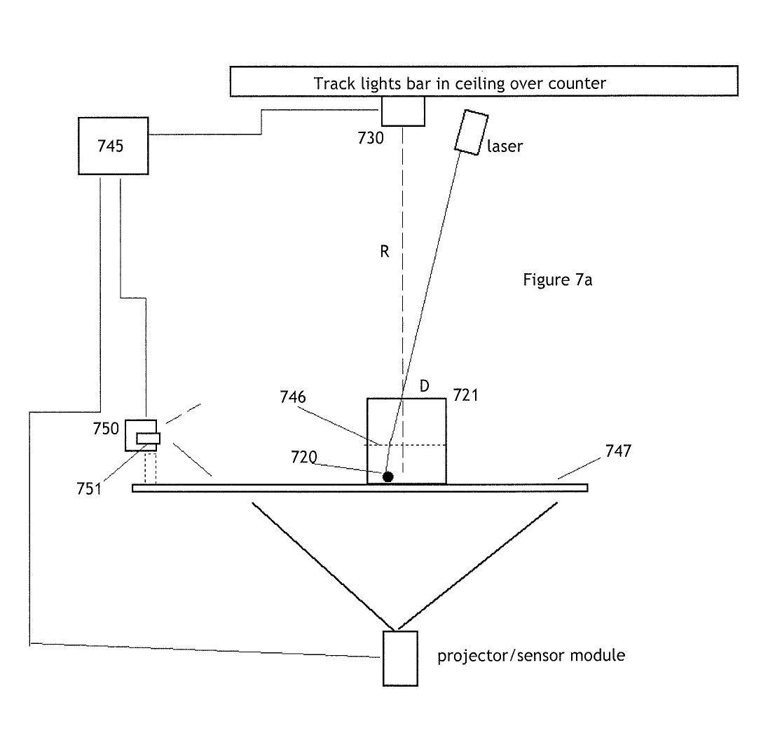

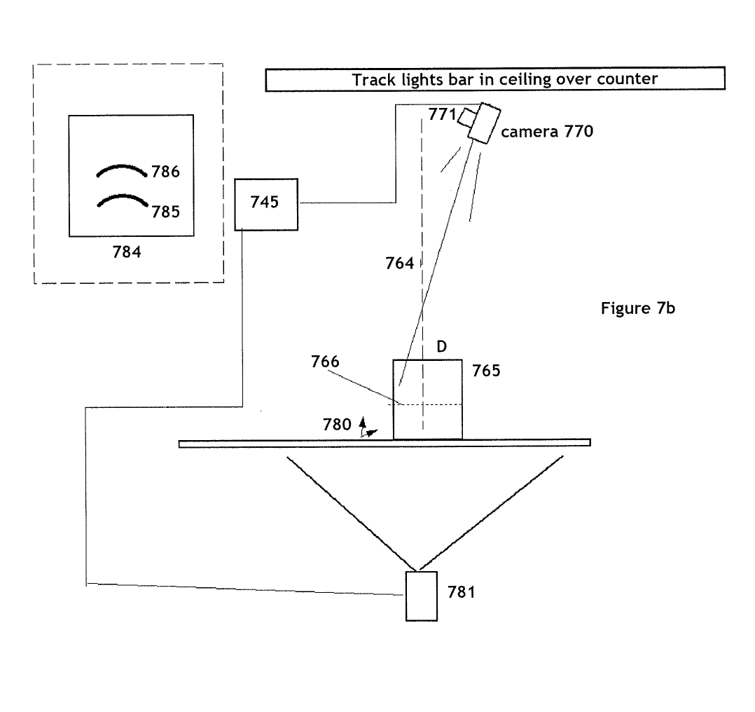

FIG. 1b illustrates a perspective view of the island or other counter 131 related to that of FIG. 1a having added features such as an integrated sink 132 and further including level detection in containers placed on measurement circle MC as discussed in FIG. 7 using a projected laser beam 133 used with projection work surface 134 illuminate by rear projection unit 140 as disclosed above. Also Illustrated is a work surface 135 having a range unit 136 with three burners on the other (the number of burners may be chosen to suit the application). The work surface maybe of ceramic glass, pyrex, or other suitable heat resistant material and provision of this heating element and does not affect the camera and projector unit 138 which are spaced away. This allows then the work surface to actually be used both as a cutting board, TV display, internet display and a range top. The screen and work surface can provide instructions next to burners on what to do next, which can be confusing if one has food on all burners for a party or the like. The control system computer such as 106 can time the time a pan is on the burner, or determine when boiling has occurred, and can as well take instructions digitally from an internet or other downloaded recipe even, automatically indicating when to turn heat down. This can be done by using a stepper motor for example to turn the range burner down, or varying current electrically if an Induction electric type for example.

The range top 135 with rear projected display is also able to be used as a keyboard or other control as well as a display. Thus one can do certain internet activities while attending to things on the burners. It is desirable to locate the electronic components of the rear projection display as distant as practicable from the burners to minimize thermal problems. Alternatively, one can utilize a front projection display as described in figures below.

The projected range display can be programmed in the computer 106 to light an indication or sound an alarm when something has timed out on a burner, or can show heat level as a color next to it if desired. All sorts of other displayed or audible data combinations are possible. Graphic illustrations from downloaded recipes can be displayed, which show the person what to do. With projection displays (and machine vision sensing), size is easily varied to suit the design of the kitchen and counter. The display can go right up to edges of various portions. Control knobs such as 143 can be sensed to operate the range or water surfaces or other functions as desired, as disclosed above and in copending applications.

This figure also illustrates an internet connection 142 (which can be wireless if desired) to enhance general control and connectivity of the device, also allowing an internet connected recipe function in conjunction where desired with sensed activity of the person preparing the food. A wonderful aspect of the invention is that allows social cooking activities with friends and family over the Internet using a TV connection built into the system and further illustrates an example of a social network cooking with family and friends using the invention. This could be for having a cooking club, facilitating instruction by a famous chef from afar and the like. For example a famous Parisian chef can in a limited class of 5 homes in the USA, conduct a cooking class. At his end, he can monitor not only their activity but the amounts in weights and measures of dimension, area, shape, size, and even color (using for example overhead camera such as 130), and assist the pupils in their work.

In this example the person's activity on the work board can be transmitted to another person's work board, together with hand positions or other data which can be seen and picked up by the sensing camera or other electro-optical sensor (either overhead or behind the workboard. Generally voice would also be transmitted, as would a separate video image, like that of a webcam 147 on pole 148, of the overall kitchen activity. In this manner one person, can show one or more others, how to shape material such as a piece of dough for example. And the dough dimensions and other parameters can be sensed and transmitted as well, more exact than today's approximate attempts at description. The invention not only comprehends that you would video the kitchen environments and it can pick up that joking in the words and instructions from one person to the other and also transmitted to the other members of a social network that are online so to speak.

One can also alternatively have a system with separate water faucet and drain and no range. Rather than on an island in the kitchen, it could be a peninsula or a conventional wall adjacent counter. One can alternatively as well utilize the invention with an “in-sink” dishwasher, in which the top of the dishwasher may be a work board of the invention.

FIG. 1c illustrates the surface of a work board 150 illuminated and sensed by a projector/sensor module 151. The Surface of the work board is curved up in the backsplash region 152 such that projection and sensing (both or individually) can also be done on the more vertical surface region 152, assuming the projector/sensor version has sufficient depth of field. I have for example found that wide angle types such as used in Samsung LED TVs have such characteristics, as do cameras with very wide angle lenses (noting further that for sensing purposes there is seldom a need for perfect focus). The camera (or other sensor) typically is bandpass filtered to eliminate the effects of overhead room lights for example, which, if florescent by be blocked by black plastic which transmits near IR. This assumes that the camera has an associated near IR light source used for sensing controls, objects, fingers etc. as disclosed.

The projector portion can be used without the camera, or the display can be of another type such as an OLED display which may be curved as shown. Certain types of flexible LCD types have been demonstrated too. The curved up backsplash area may in one example provide as an easy to read announcement or note board, and like other screens may display pictures and the like. Typically the backsplash is vertical and located adjacent a wall.

Also illustrated is a projected virtual keyboard 155, which may be used when desired, for example on pushing button 156 (real physical switch or touch icon as required), relief features at the key locations. Other projected information such as an internet display to allow shopping on line while cooking or performing other activity, can be selected by knob 157, which information and touch sensing capability can be provided in addition to the keyboard just mentioned, or instead of (which allows larger letters). Navigation on the data is performed using the touch capability of the invention if desired.

The virtual 155 keyboard has no physically moving keys thereby preventing debris from getting into them as a result of work done on the work board for example. However relief features small in nature can be used if desired to tactilely reference key or other locations as pointed out in co pending applications. Relief features such as tiny ridge 160 can be provided as desired to indicate where one or more letters are located on the virtual projected keyboard. A big advantage in this application as one can glance out of corner of eye at a key, while doing something else such as a cooking chore, and feel it.

Information that can be presented can be for example, diet advice from material measured. Cooking advice or automatic transfer of info to cooking operation or Cutting advice from material extent determined. Approximate volume, area and extent of food objects on surface of the work board may all determined may all be determined using the camera or other electro-optical sensor of the invention. Since the data is projected, the work surface can desirably also be removed for cleaning, which is particularly helpful if the screen surface contains indentations or relief elements or other shapes as tactile references, which could trap debris. Some work surfaces can be washed in a dishwasher if sufficiently small.

On a simple to use version with a knob selector such as 157, other knob positions besides “internet” (which would display a browser page such as IE) might for example include:

1. Baby's Room. This would bring up on at least a portion of the screen and workboard 150 a TV monitor image of the baby's room and crib, or to observe children playing in other rooms for example.

2. Security. Images taken from security cameras may be displayed, optionally cued automatically, for example by an infrared sensor signal indicating that motion nearby has occurred.

3. Cookbook (with further selection by other means of page desired or whatever). One may for example have a recipe number touch icon.

While a touch icon or other touch screen function can be used to select functions using the invention, the knob 157 (and perhaps other physical knobs also on the screen) represents a familiar and tactile way to do this which can aid persons in operating the device. And it generally is faster and easier to use in times of distraction.

An additional use of the invention is to record and display family notes. Input can not only be by touch screen, but by also laying a written page such as 170 face down on the work board (alternatively may be face up if data is obtained with camera or other electro optical sensor 130 overhead). A rear projection or other rear sensing work board in a transparent region or even in a dispersive region (especially where dispersion is at or near the top surface), can be used to read handwritten or other notes placed on the work board, which can be stored in computer memory for later display, or display on other monitors, or put into file locations such as that of recipes or other files as desired. If sensed overhead, the written page can be sensed directly for example from camera image taken by a camera 130. It should be noted that a recipe book pages can also be recorded in this way, so that one's prized books can be used without spilling things on the book, simply by calling up from computer memory the jpeg (or other) image of the page(s) desired. Note that this function can read in photographs, hand written notes and can also be used to determine handwriting. Also as disclosed in co pending applications, a gesture signature can be read if desired, for example to verify that operator (e.g. a parent) was qualified to operate a particular piece of equipment, or to change a computer function.

It should be further noted that the camera or other electro-optical sensor below the screen can also be used to read coded program instructions, as can the camera 130 overhead. This reading of coded program instruction activity has been well treated in several co pending applications by Peter Smith and I incorporated by reference. These applications disclose simple paper based methods of doing common tasks using the computer as an aid, and are particularly suitable for those persons who are not computer savvy, or for those who have notes, receipts, or other info in written form and just want to do something with it quickly, like file it in a data base, or email it.

FIG. 1d illustrates further the use of the work board as a cutting board for slicing vegetables, meat or other objects. As noted the work surface can be made out of glass or hard plastics or other materials that can withstand the work that is to be performed on them. Some of these materials to can withstand a knife being used on them for example in the mode of a cutting board.

In a representative but by no means exhaustive example, work surface 175 is being used in this case to cut a piece of meat. In this case a slice of meat 180 lying on work board 175 is to be cut into two parts. A projected outline 181 is presented by the computer showing the meat in its present form (having measured the outline of the meat with the camera or other electro-optical sensor of the system, and then showing the person an additional step. For example to cut the meat along a line a-b. Once the person has made this cut, the camera can be used to determine that there are now two pieces in the right sizes and instruct the person what to do next. An advantage of this system is that the instructions can be in any language in which the person is comfortable. Pictographs or other instructional information and is well voice files in different languages as needed can be provided by the computer on the loudspeaker. The computer may be programmed either by the user or directly from a recipe guide downloaded from the net or otherwise, to show a given size and shape based on the meat type such as steak being cut. In this manner the approximate weight and cooking time are known, if the rough thickness of the meat type is known. One can enter the weight on the package pre cutting, and the subsequent portions then can be estimated from the cutting data

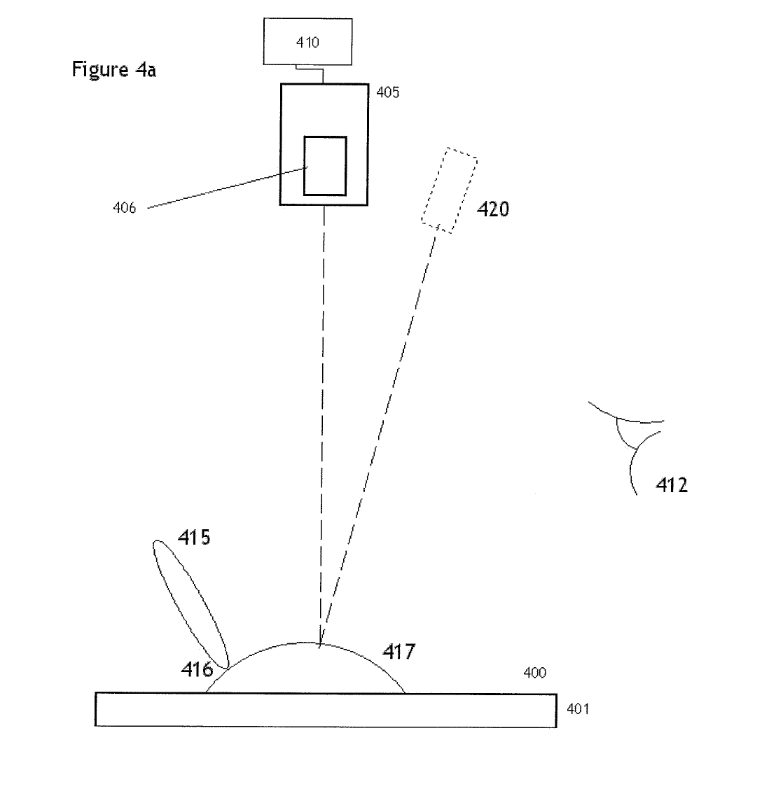

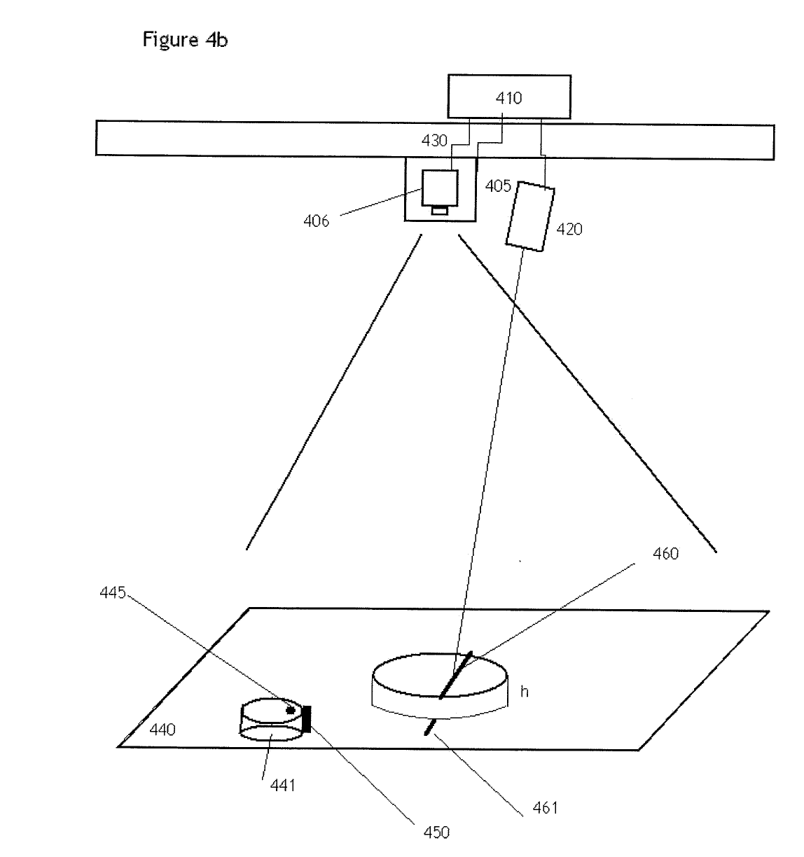

The cutting procedure just mentioned is easier if the projection of the desired shape and size is from overhead (see for example FIG. 4). Where it is from below as shown here, the size should be projected a bit larger than the actual desired size, so you can see the projection while cutting to the inside of the projection.

While illustrative of meat, the technique can be used for cutting fish, dough, broccoli, vegetables, or other items as well. The projected image may also be used to instruct the user as to what to cut as well, such as a piece of steak that “looks like this”, so to speak.

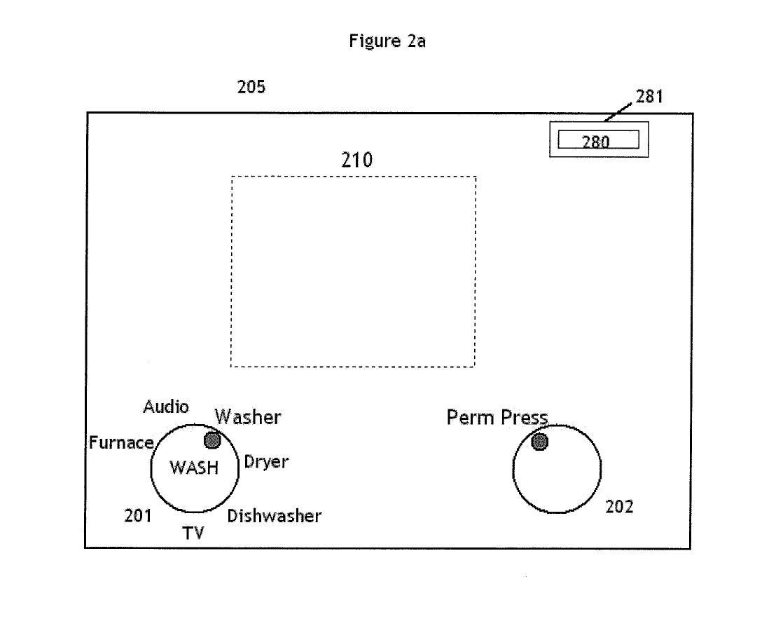

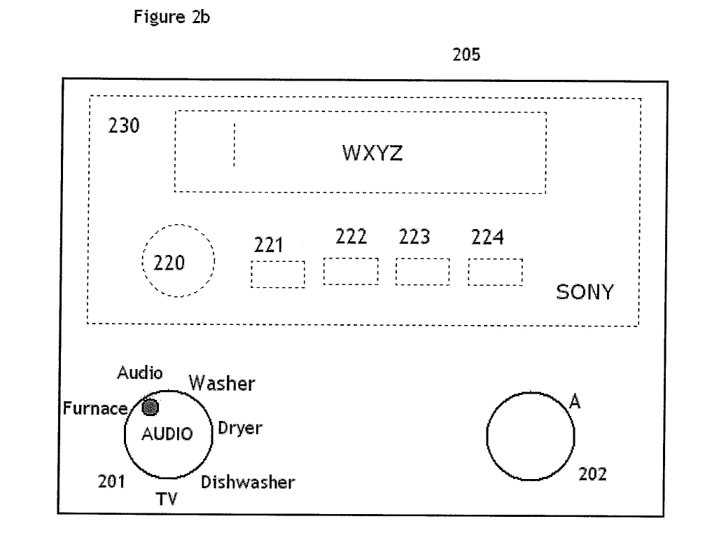

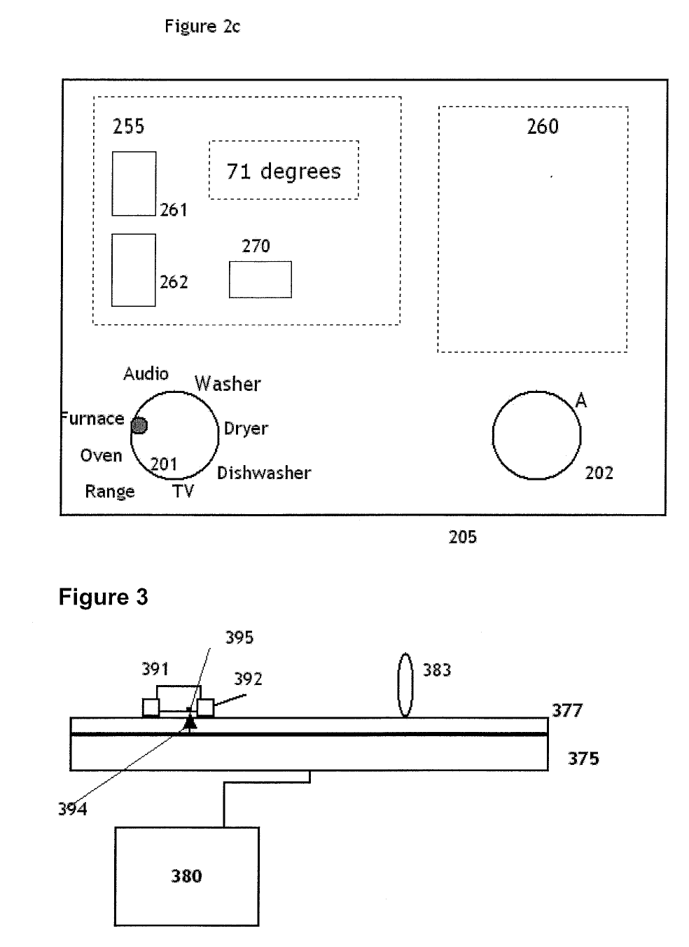

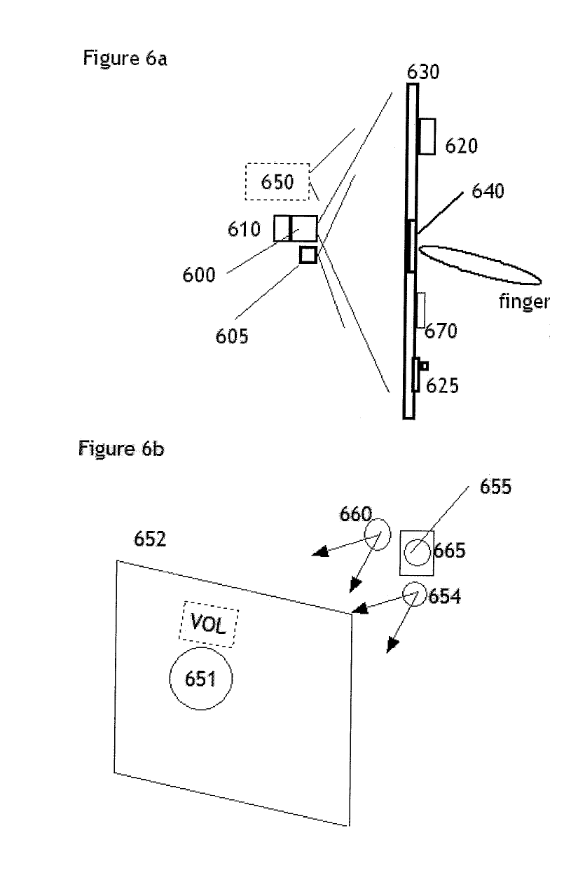

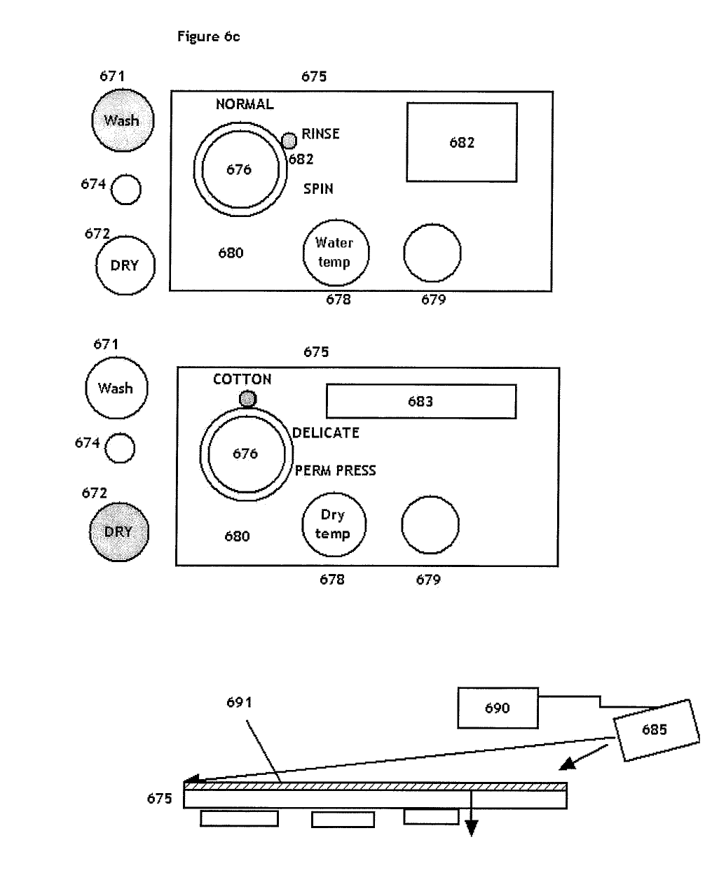

FIG. 2a illustrates interconnection of the countertop of the invention to other appliances or data devices in the home and further illustrates application to an appliance control panel. This is for any home control system, but logical place is kitchen. A person in the kitchen charged with home tasks then would gravitate toward use of the control system rather than the controls on the washer directly which increasingly are hard to understand. And he or she could track progress from the control panel in the kitchen, without having to go down stairs for example to the laundry room. In addition, it is likely that some cost can be cut out of washer and dryer and functionality improved due to the massive increase in human comprehension of functions provided. Further control cost savings approaches are noted in FIG. 6.

In one mode of interaction, shown in FIG. 2a, the function of knobs (or other control details such as switches) such as knobs 201 and 202 on the screen and control surface of the work board 205 (viewed in top view) may be reconfigured as discussed in many of my copending applications, which also have illustrated such a control surface on the wall of a home. As shown for illustration, in the mode shown knob 201 selects the device or function, and knob 202 selects the operation mode for that device. Labels can change on knob 202 to suit the device being controlled. As shown the words PERM PRESS are for a washer cycle. The other non-selected features (e.g. Normal Wash) labels can be made darker in one mode of operation. The screen surface of the work board or within the work board if not comprising the whole thing) can then illustrate graphics and other aids to operation of the device, in this case the washing machine. Graphical images representing functions of states of the washer can be manipulated if desired on the touch screen of the work board. The special settings for the cycle that are today controlled by buttons etc. at the washing machine, may instead (or optionally in addition) be controlled from the kitchen at some savings. Lettering can be displayed on the knob, or next to it or both to indicate functions, which labels can also change in size or color or in another way to indicate selection. A picture 210 of the device controlled including features of it, can also be displayed if desired

It should be noted that knobs 201 and 202 for example of FIG. 2a could be virtual displayed knobs, rotated for example with a two finger twist motion as shown in my copending application Ser. No. 11/272,868. This concept can be expanded into controlling all systems in this manner, however actually displaying a virtual map of the control on the actual face of the device, and using virtual controls on the control panel to map them, instructing computer such as 106 to transmit signals to them to execute the functions desired. Such signal transmission can be wireless or wired as desired.

For example consider FIG. 2b which illustrates, on the workboard screen surface, the projection (or other display) of a virtual mapped control panel of an external audio system (for example a SONY one you have now, but which has the necessary input connections to be controlled remotely) whose operation is achieved using virtual rotation of the volume knob 220 and operation of the virtual pushbutton station selection buttons 221-224. The background image of the SONY control panel displayed on the screen 230 may if desired be simply a JPEG taken with a digital camera of the actual item (or a downloaded shot from the internet), in which the virtual control functions are overlaid. Turning of knob 220 with two finger (typically thumb and forefinger) twist motion, adjusts the volume up or down, just like turning the physical knob of the real Sony audio system located in the living room say. The call letters of a station selected for example, WXYZ, can be displayed just as they might be on the actual device. Or if you want, you could reprogram the system for any control layout or display configuration desired. Generally though, the idea is to keep the controls the same, to make less confusion in the home.

In this example the same real knob 201 is shown selecting the audio system control panel, however this too could be a virtual icon displayed selection button or other virtual control. Or it can be a physical switch or whatever. The other real knob 202 shown previously can be in active if desired in this scenario, or could be used to independently control other functions which could override the system. For example if position “A” on knob 202 was selected, all items displayed would relate to the range top or to cutting board tasks, or to show a baby room video monitor picture, or the internet, or whatever function A was assigned. All these choices and more might be provided on knob 202 if desired, or via touch icons, or any combination thereof.

FIG. 2c illustrates a virtual displayed control panel 255 for heating and air-conditioning services containing touch icon up and down temp switches 261 and 262, temperature setting display 265, and heating air and fan on switch set 270. The spare space on the work board screen is used to show a display area 260 of weather forecasts for example off the internet for the period desired, to assist one in setting the controls for example. Knob 202 may if desired be used to assist in any of these functions as practicable in the furnace mode selected, for example to scroll down and select further information on the various days whose weather is presented. An advantage of the invention is that such associated information can be provided in big easy to read form, right near the control, and in a place most often used in the home.

Further illustrated in FIG. 2a is an application of the invention in which the user of the control system or appliance plugs their cell phone 280 into a slot 281 in the device, in this case into work board 205. The cell phone can be connected and charged in so doing and interfaced to the system computer 106 such as It plays tunes stored in the cell phone, or uses it to collaborate with others over the cell net. And a playlist of tunes or phone numbers can be displayed on the screen of the work board to aid quick selection of tasks to perform. If sufficient processing power is available in the cell phone, the computer of the cell phone may be used to operate some or all of the system as an alternative to computer 106. This also allows one to operate other such control panels with your information carried in your pocket.

Another displayed control panel can be a virtual mapped panel of a external clothes dryer. Realizing that this can be the panel of an external washer as well, and that both such devices are located in regions remote generally from the kitchen, it is possible to control both from this panel, which can save cost at the actual device. Without going downstairs, one can see status of laundry machines too.

Alternative to the projector display of FIG. 1, shown in FIG. 3 is a work surface LCD display 375 having incorporated with the LCD pixels, a matrix of sensing detectors such as that made by Sharp company, albeit today in smaller sizes than depicted here. To prevent damage, a protective cover 377 of lexan plastic is provided over the top of the display. Images obtained with this display of light from the display or the room striking the detectors in the display are processed by computer 380 (which is also used to drive the display) similar to the camera images of the rear projection based systems I have disclosed. This arrangement can be used in other workboards of the disclosed invention too, and has an advantage that its thinner than rear projection devices. However, it is less developed at this writing, and the choice of surfaces, sizes, configurations and activities is more limited. It is also much more expensive to repair, as the LCD portion can be broken for example by dropping a heavy pan on the device unless the protective cover is so thick as to provide less than idea images when one looks through it. The device can see the position of finger touch 383 and using light from the display 394, detectors collocated in the display can see a datum 395 on the back of knob 391 rotating in race 392 mounted to cover 377.

FIG. 4a illustrates further the case discussed in FIG. 1 where the projection of information and the sensing thereof is done from overhead, along the lines first mentioned relative to camera 130 in FIG. 1a. This arrangement is also described in several copending applications for example Ser. Nos. 11/184,076, 11/832,134, 11/980,722, and in a related context in referenced applications by Peter Smith and I. As shown, worksurface 400 on work board 401 is projected on by projector 405 and viewed by camera 406 both driven and processed by computer 410. The image on the worksurface is viewed by user 412. The position of one or more user fingers such as 415 or ones hand can also be sensed by camera 406 as desired in this example the persons finger tip 416 is sensed touching cookie dough mound 417. A structured light line projector can be provided 420 as is known in the art, which can be used, in conjunction with images taken by camera 406 to contour the shape of the dough 417 as the users finger pushes it on the work surface. Alternatively and more accurately, the laser line can be caused to automatically sweep the surface, for example by moving the workboard itself by an electric motor, or sweeping the laser beam using a rotating mirror in the horizontal direction. Grids rather than lines can be projected, if mechanical movement is not desired. Data taken can be processed by computer 410 and presented to the user on the projected image or other display as either a shape, or a calculated volume. And from the later, an inferred weight, if the dough density is reasonably known (something that could be downloaded from a recipe for example). This allows one to also calculate the estimated caloric content of the dough, and through a suitable calculation, the finished baked cookie. Prediction of the calories, allows one to cut back the dough size, if lighter less filling cookies were desired the light section data from above, can be also used in conjunction with area and shape data obtained from below using a rear based camera system.

FIG. 4b is a perspective view of the worksurface 440 projected on by projector 405 and viewed by camera 406 both driven and processed by computer 410. The projector and sensor are mounted to a track light fixture 430 in the kitchen ceiling, though this could be any other suitable mount. Also illustrated is the sensing of a knob 441 using either a dot mark on the face 445 or the pointer 450. A light line 460/461 is shown being projected by line projector 420, with the shift in the image on camera 406 between 460 and 461 indicative of the height h of the cookie (in this case a flat cookie). Volume and shape calculation using systems of this type is shown in my U.S. Pat. No. 5,940,302. In the flat cookie case the volume would be calculated by determining the diameter of the cookie (obtained by viewing the camera image for example), and multiplying it by Pi times the height determined at all points, which in this case is the same number h.

The camera does not have to be directly overhead, and could be mounted on a pole sticking up from the counter (such as webcam 422 on pole 423 in FIG. 1b) and viewing objects on the workboard at an angle. It is noted the camera or other electro-optical sensor used to sense a kid near or on the range top and sound an alarm and turn burners off. Note that for some applications such as this, an ultrasonic sensor or a radar sensor might be used, interfaced as well to computer 410. The camera can also be used to determine if water is boiling on the stove, and other conditions of interest which can be annunciated or used to automatically cue a control (such as turning heat down).

The overhead version has several advantages over the rear projected version. For example it saves space underneath the counter for drawers, microwave, or other things. The projector and camera “Throw” distance in this case is comprised simply of something less than the ceiling to counter distance in free space. The workboard is also anything you want, as long as you can see the image on it, and does not have to transmit light. The primary disadvantage is that your hands, head, or other body parts can obscure the image projected, as can objects in general on the counter top. However with some care, and judicious choice of what to project where, this can be largely mitigated. For example detailed information is best projected in a region away from the immediate working region. Indeed the invention comprehends sensing with the camera and motion, hand recognition software or other means where work is taking place (e.g. cutting a steak) and signaling the computer to controlling the projector to project recipe or other information in another region.

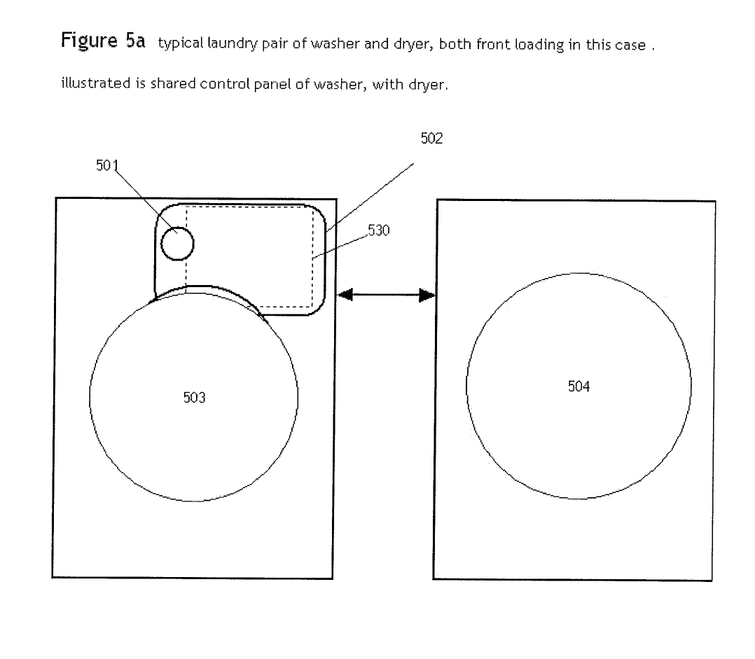

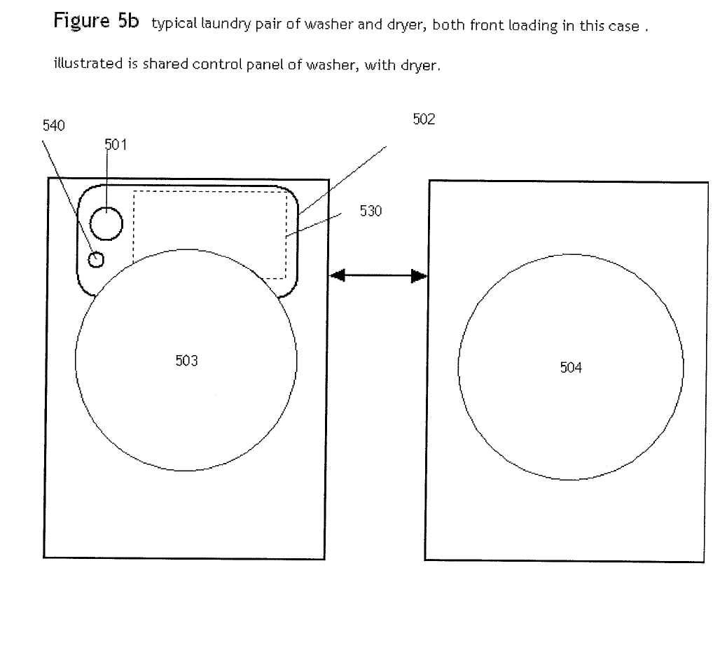

FIG. 5a illustrates application to an appliance control panel, in this case a washer 503 or dryer 504. Note that one panel can serve both, since it can be reconfigured. For example the knob 501 of the control panel 502 on the washer 503 can be reconfigured from controlling wash programs to dryer programs, using the RTD invention discussed in many co pending applications. In this case cost can be saved as one panel can serve both washer and dryer, while still providing clear, large, easy to use controls for each. An alternative manual rotary switch knob of conventional design can be used (instead of solid state devices), which can be motorized for remote computer control.

As noted for example in my pending application Ser. No. 11/832,134 the display and control surface 510 can be illuminated by a low cost projector/sensor module which may be based on high volume cell phone applications which are believed to be coming. This allows then total reconfiguration of functions and utmost flexibility of the system using both tactile knobs similar to existing washers, but entirely electronic and reconfigurable.

The invention just described utilizes solid state relays or other devices to switch functions as needed. This is generally more expensive I believe than old fashioned mechanical based knob rotary switches Where cost is paramount, a manual knob of conventional design can be used, which knob can be motorized (for example with a stepper motor) to allow remote computer control by unit such as FIG. 1. Labeling however can be reconfigurable due to the projection or other display system. Because the information displayed on screen 510 can be of anything, not just a control function label or tell tale light, one can for example wirelessly connect it say to a TV monitor in a child's room, so that when you are doing laundry you can keep tabs on things going on in the home, or in the yard outside. Other functions mentioned above might optionally be provided too. Note the interesting feature that the control panel can wrap around the drum, increasing the screen size available for touch function, TV watching or other features showed in dotted lines 530.

FIG. 5b illustrates the same arrangement but with a different shape control panel and larger drums. Shown in addition is a physical “hot button” switch 540 to change the screen and control surface from washer to dryer and back as needed. The dual control of washer and dryer is valuable for those machines having a combined washer and dryer function, such as sold in regions where space is constrained, as in Italy. In this case the control panel can optimally provide information for both functions, and simply be switched between when operating the machine in one more or another. See also FIG. 6c.

The same control panel idea can be used to control a range and oven combination, or range and microwave, or any other grouping of appliances or other devices to be controlled. And the controlled devices do not have to be collocated. For example, the panel 502 could also control in addition to the washer and dryer, a audio system, or TV function of the device. Or even the internet. Along the lines of the work board disclosure above.

FIG. 6 illustrates a low cost control arrangement of the invention, which in the simplest case is used only for control, with little or no sophisticated display capability. It is ideal for appliances, trucks, cars and many other applications not requiring sophisticated display interaction. The central premise, also disclosed in my co pending applications, for example Ser. No. 11/980,710 is that a single low cost camera 600 used for cell phone or automotive applications, together with a LED 605 can be used to illuminate and sense the position of a variety and a plurality of physical control details such as knob 620 and slide switch 625 on control surface 630. Image data collected by the camera is processed by simple computer means 610, such as a DSP integral with the camera, and outputs provided to I/O used to effect the control selection made by the user interacting with the knobs and switches (and other controls such as dials sliders, etc. as desired)

This system is very inexpensive, since I have read projections that the camera and computer portion could be as little a few dollars in large quantities, and the led may only be 10 cents, if retroreflectors or other high contrast targets are used on the control details such that little light is required. The control here is not exposed to ambient light so no need for higher powers or sophisticated computer processing. Nor is there a need for near in operation or bandpass filters, which may be used if some ambient light issues persist.

Not only is this aspect of the invention inexpensive (on the order of say 30 cents per controlled variable or device (not including the plastic items) for a panel with 10 controls, but it also is easy to design, and customize. There is no need to make a special circuit board for example. This has untold advantages in many areas. It allows very economic small control panel volumes. The computer also can optionally take in inputs from other sensors and controls making the system even more versatile. The camera can also sense indenting positions of a overlaid member such as plastic member 640 shown. This allows the member to be used as a touch pad, like on a laptop, or with touch switch positions like many appliances have today. Examples of suitable sensing methods are shown in my co pending applications. The controls are shown in side view, and other controls such as knobs switches and the like can lie on the surface extending out of the plane of the paper.

One may also use a version adapted for the FIG. 5 application including two fixed projectors 650 (spaced out of the plane of the paper in this view) such as disclosed in my Ser. No. 11/980,710 application. One for the dryer control surface image, the other for the washer, for example. In this case, the region of the control surface 630 on which the image data is to be projected needs to be transmissive and dispersive in order to create a rear projection screen, as disclosed in copending applications. The added cost is very low (for example 5 dollars), but there is no ability to provide video or real time information unless a separate display is used such as an LCD panel, for example a strip LCD or led type or other flat panel display 670, in this case requiring an electrical connection to the control surface 630. Where cost can be afforded one can thus use either an lcd panel or other conventional display or alternatively a low cost LCOS, MEMS, or other video projector for example as may be used in cell phones, remembering too that the drive circuitry for the video display has a cost as well. Such a projector in an appliance can also be used to provide a TV image or internet connection to the user. It is noted that the control surface 630 may be curved or irregular, without affecting generally the ability of the camera to see the control information desired, such as knob position, finger touch position etc.

FIG. 6b illustrates a method of providing illuminated labels for night driving in a vehicle using the apparatus of FIG. 6a. FIG. 6b illustrates a one method of providing illuminated labels with an apparatus of FIG. 6a. As shown knob 651 is mounted on control surface 652 and is sensed by camera 665 to determine rotational position, using light from LED 654, in this case an IR LED at a wavelength which goes through band pass filter 655 in front of the camera, such that light at other wavelengths cannot meaningfully affect the camera image. At night, white LED 660 (which could alternatively be colored) is turned on, and passes thru a thin slot cut in the member 652 which has been laser cut with the word VOL (or Volume, for a radio knob). The led 660 can be controlled to be bright or dim as desired, and within reason numerous other such engraved slots can be cut for other markings. If desired, and if a white LED is used, one can put colored filters on some of the slots in order to make them appear different colors. The filter is used, if needed, to cut out the vast majority of ambient light passing thru the slots from the passenger compartment.

FIG. 6c illustrates a combined washer and dryer system for an individual appliance employing a small sensor/projector such as disclosed in my copending applications. Projector and sensor combinations of this type for example can be based on the Microvision brand “pico projector”, which is slated for cell phone application. The projector 685 is controlled by computer 690 which receives inputs from the knob, switch and touch screen commands of the system. Video images are projected obliquely onto the rear of the screen and control surface 675 on which 3M TRAF turning film has been placed to turn the image toward the user. The projected image is over scanned on the screen such that all the screen surface desired may be illuminated.

Two states are shown, each activated by electrical power and control button 671 or 672 as desired, to operate a washer or dryer portion of a machine, or pair of machines. Main control and selection knob 676 which may optionally have a stylish and informative screen in its center as disclosed in my pending Ser. No. 11/045,131 application, and other applications. The knob may be in the form of a ring of a radial thickness t, and if desired (and as disclosed in copending applications) may be designed in such a way as to be able to be pressed in or pulled out, to start or stop a cycle, just as many conventional knobs are today. The knob indicator may be a physical pointer, or it may as in 682 be simply projected on the screen surface, or alternatively it may be projected on the knob face or other knob surface. Two other knobs are provided in this one example 678 and 679. More knobs or switches or sliders or other controls may be provided as shown in copending applications. These controls may be optically sensed, but they may alternatively or in addition be sensed using electronic means known in the art. One of several desirable versions of the lafter is a capacitive touch switch.

A region of virtual touch inputs which may be optionally provided as disclosed in copending applications is shown as 682 for the washer mode and 683 in dryer mode. These functions or indicators as desired can be different for different modes. Note that when it is desired to connect to another service other than the washer or dryer such as an external program source to listen to watch TV, the optional button 674 can be pressed, which turns the knob 676 into a auxiliary selection knob, and other images presented while all the label and other washer function indications can be deleted, or their letters or indications made smaller or otherwise less visible. The washing or drying action can proceed if engaged, as desired.

As noted in my copending applications, the image of the TV can be projected to appear right on the screen of on the knob (or switch or other control). This in practice I have found is generally not overly disruptive to the overall understanding of the image, particularly if the knob rings are small in radial thickness so as to not obscure the image substantially.

As shown the projector 685 (controlled by computer 690 which receives inputs from the knob, switch and touch screen commands) may be angled to project obliquely onto the rear surface of the screen and control surface at an angle such as shown in FIG. 4 of my copending '868 application (related to U.S. Pat. No. 7,084,859), as well as in several other copending applications. In the case shown generally desirable with matrix type image chips, the chip may be tilted such that the projected image plane is in focus on the screen from one end to another. If this technique is used, the image may be corrected in the computer so as to present a uniform magnification across the screen. The screen is over scanned at the far end from the projector such that the near end can be fully illuminated.

This system allows one to use projected or otherwise displayed graphics to differentiate appliances, and as pointed out in earlier cases, one can change the control panel and screen shape with ease as well, including the use of curved shapes and cut out peripheries. One can easily change language to suit different markets or buyers. And one can display patterns, colors and the like also on a knob or other control element face as pointed out in my Ser. No. 11/045,131 application and elsewhere

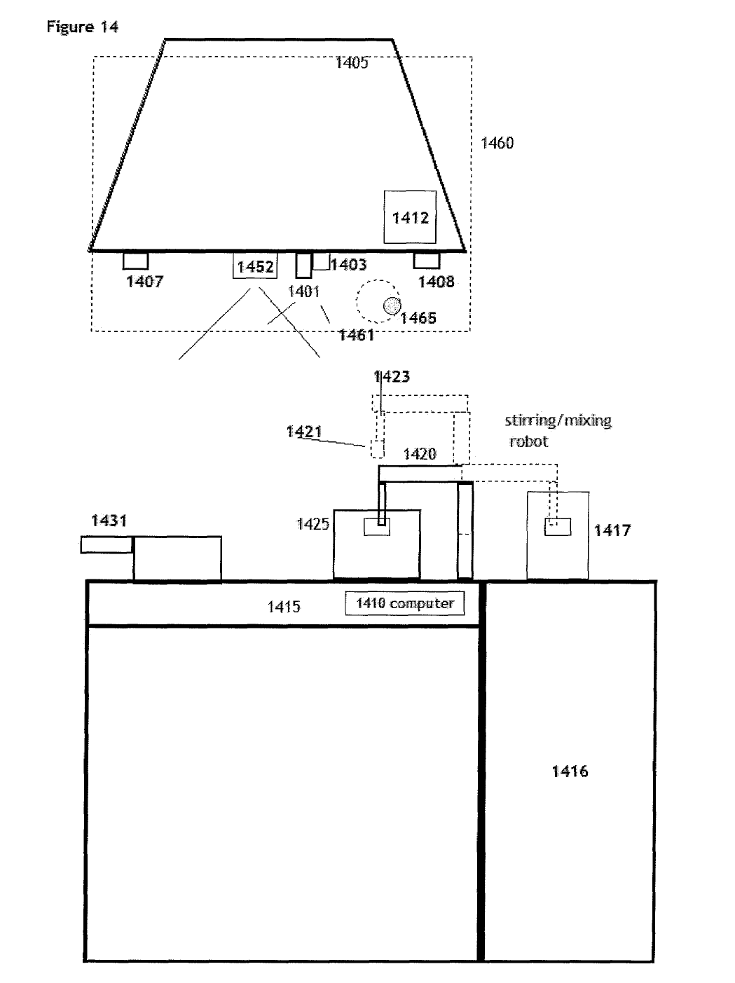

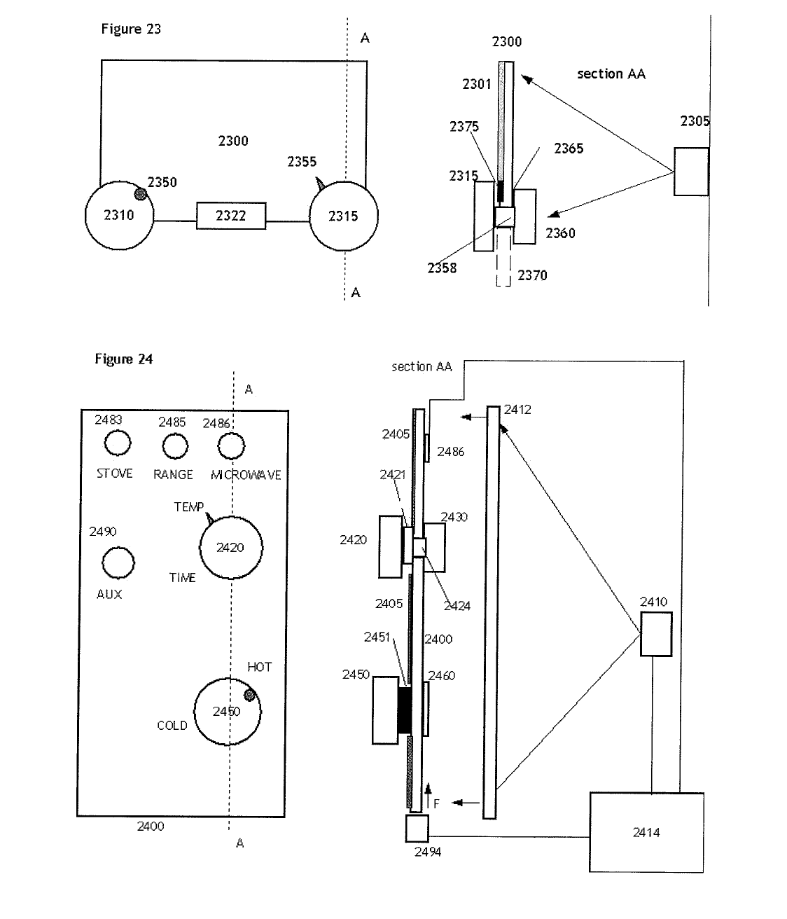

The invention in its simplest form can use a camera or other electro optical sensor just to sense control positions on the screen and control surface. Or it may use a projector as disclosed, and use conventional control sensing technologies, such as those illustrated in FIG. 23, of importance is that the function of the device can be used to control multiple appliances as noted for the washer and dryer above. For example another example would be in FIG. 14, where the same computer 1410 and control system could control the range, oven and microwave. Any or all. The control panel unlike that of FIG. 14, could be located on the front or back of the stove, just as in conventional devices today.

One can also control in a similar manner different functions of the same device. For example, the control panel such as FIG. 6c in a dryer, can be switched from a dry cycle specific control panel, to an over all dryer control panel, to an entertainment panel, showing a TV show, or internet feed. If desired, it may incorporate more sophisticated touch screen functions too such as the multipoint type of my '868 application and U.S. Pat. 7,084,859.

FIG. 7a illustrates an embodiment of the invention useful for measuring liquid level in containers, which further employs instructions displayed on the work board surface. A major difficulty for some people is the measuring out of materials particularly liquid but also granular materials that are typically put into a measuring cup. It is contemplated that the invention can aid this by obtaining data from the recipe is just what is in fact, needed. And by then either displaying this to the person or by in addition, monitoring the amount of material that the person is putting into the top of the container and telling them when they of put enough in perhaps giving him a little bit of warning ahead of time so that they can slow down the rate of pouring. Note that can have display of liquid and info right next to where you put the container down.

One can display as shown in FIG. 3 on the surface (shown in rear projection, but can also be front projected) a projected measurement circle MC where you should put the container, such that the camera can determine the height of liquid in it, and compare that amount to a pre-calibrated value for that container or container type (e.g. one of a set of 8 identical whiskey glasses say).

The camera 730 analyzed by computer 745 can sense liquid level 746 by watching the position of the laser beam spot 720 projected thru the liquid (which must be reasonably transparent in this case) to the bottom of the container such as drinking glass 721. Due to the index of refraction of the liquid, the position of the spot will be proportional to the height of liquid in the container. If the liquid or granular material is opaque however a different laser triangulation approach can be used, wherein the laser spot is now seen by the camera on top of the liquid, and shifts in the image plane of the camera as liquid (or granular material) rises in the container due again to the angulation of the laser beam to the camera axis. Information concerning the volume of liquid 747 is displayed on the screen or announced via a loudspeaker, as desired.

It should be noted that the liquid level can also be seen from the side, assuming the container is transparent and of reasonably plain design, as shown using camera 750 whose image is processed by computer 745. For this application it is most desirable to light the glass and liquid in a backlight mode, but a front light for example from an IR LED 751 from the camera side works, though attention should be made to position the camera and light source so as to avoid the direct and bright back reflection from the side wall of the container. Normal room light can also work in many cases. The meniscus of the liquid creates a darker portion of the image than does the air or the liquid above or below it.

The side viewing technique also allows granular material height in the container to be determined, since the top of such material creates a contrasting image to the air above it. The side viewing system will also sense milk and other opaque liquids, it is also noted that the side viewing system generally is more rapidly respond to pouring material in and further the pouring does not get in the way of the camera field.

An alternative top sensing method is to position the camera 770 at an angle to the axis 764 of container 765 and worksurface normal as shown in FIG. 7b and look at the sidewalls of the container which preferably are light colored and diffusely scattering. The demarcation 766 between liquid (or granular material) and sidewall can be discerned under most lighting conditions. Where desired a special light source 771 such as an IR LED (so as to be invisible) typically collocated with the camera can be used. The image of the demarcation line after processing in relation to the camera image sensor 784 is as shown the inset (dotted line) for two different liquid heights, lower in container 785 and higher, 786.

If the container 765 has transparent sidewalls like a drinking glass, mason jar etc., then the level can be determined using back light such as 780 from the projector 781 below the work surface screen which can be directed at location 780 on purpose to illuminate the demarcation. Calibration steps for liquid measurement in the apparatus of FIG. 7 are in one example:

First, place a chosen container on the workboard at the position indicated. Optionally measure, using the camera 730 or the projector sensor module, its diameter D or another variable of its nature so it can be recognized later by the camera and computer system

Second, fill the container with first known amount of liquid, say 100 ml. Determine the change in range R from the bottom of the container to the liquid.

Third, pour in another known amount and determine that range if one doesn't pour in standard calibration amounts, enter the amounts poured in using the keyboard. The sensor is proportional, this is all that is necessary to obtain volume over the whole range—as long as the glass itself has a constant cross section and the angular correction factors are known as they can be for any given setup. If it doesn't, like a teapot, then simply calibrate using common amounts, such as a half cup, quarter cup etc. and use it to measure those points to create a lookup table for example.

This procedure can be done once for each container type you want to use. Since all measuring and calculation is typically digitally based, it is typically not necessary to do it again. More sophisticated calibrations with more data points are also possible.

Alternatively the manufacturer of the apparatus or a third party can provide special containers which have known calibration values for height change vs. volume. These values can be inputted by CD or flash drive for example to the computer, downloaded from a web site or whatever is appropriate. In this case no calibration in the home is required; assuming the range sensor itself is linear. The calibration values for example could start with a measurement of an initial measurement of the container bottom without liquid.

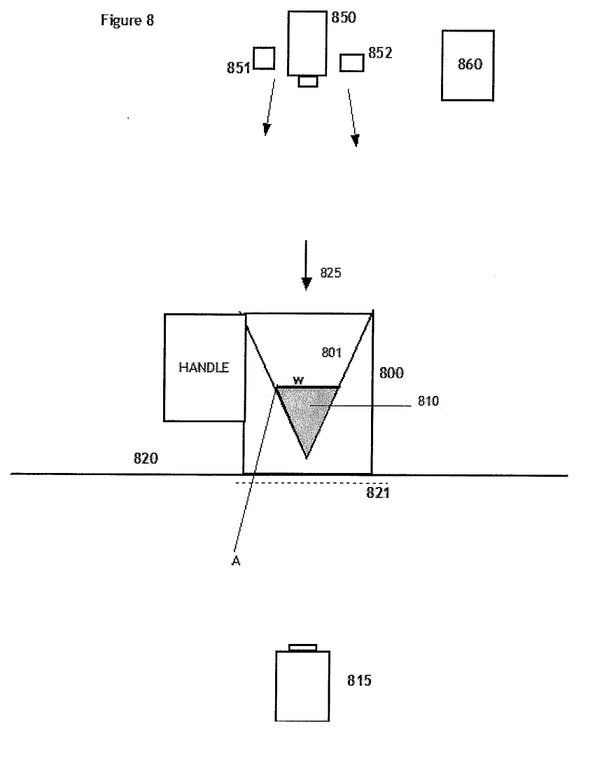

FIG. 8 illustrates level measurement employing a container 800 having for example a cone shaped inner region 801 of known slope containing the material to be measured whose optical characteristics vary with the level of liquid or other substance 810 which is present in the container. A camera 815 below the work surface 820, where a demarcation ring A is observed from below where the liquid height ends along the cone shaped inner wall of a special plastic or glass container placed on the work surface at a location where lighting 825 from above makes the ring clear. Machine vision software in computer 860 analyzes images from camera 815 or alternate camera 850 (connecting wires not shown for clarity), and using a known value of slope, or a taught response of the container to filling with various volumes stored in a lookup table, determines the volume in the container. Suitable lighting can be provided by LEDs such as 851 and 852, an overhead projector if used for information presentation or other purposes, or other sources. The sharper the angle of the cone, the more resolution of liquid height, as the liquid moves further sideways for any given amount poured in. The detection is geometric, but most sensitive for smaller amounts of liquids. It is however possible to have a more linear response by simply sloping only one side of a generally round container. The work surface at the measuring location should not be too diffusive as otherwise the ring image becomes indistinct. It is also possible to have a portion such as 821 of the surface which is nearly totally transparent with little or no diffusion. Normally, little or no light is projected at this area from below, as it could directly hit the users eyes. The area is typically small, as containers one might use are generally 6 inches or less in diameter.

In another variant, the projector on the rear can be used to illuminate the demarcation through the bottom of the container. In this case light is projected thru the bottom of the container and the juncture between the sidewall of the cone and the top of the liquid is immediately visible. Note that the transparent portion of the work surface can be replaced if desired with a diffusive one, or a diffuse member be laid over it when measurement is not required.

If it is desired to not rely on any optical element below the work surface, then both illumination and camera sensing from above can be used, such as camera 850 observing the top of the liquid or material in container 800. In this case the width or diameter w of the material at the top of the cone can be determined using differences in reflection from the immediately adjacent sidewalls.

If material volume data is obtained and material type is known then weight can be calculated for a known material density. And in some cases one can infer a certain weight from the measured area of the material, sensed above or below the work surface, by knowing the characteristics of the material whose area such as that of the pizza dough in Cartesian axes of the work surface can be determined easily by the camera. If one knows that is typically go that you are forming of such an area you can almost assume a certain height, distribution and approximate a volume. But it is not particularly accurate. Some recipes don't require accuracy, some do. In the case of those that require more accuracy, one can use a deflecting work surface that serves as a scale for example

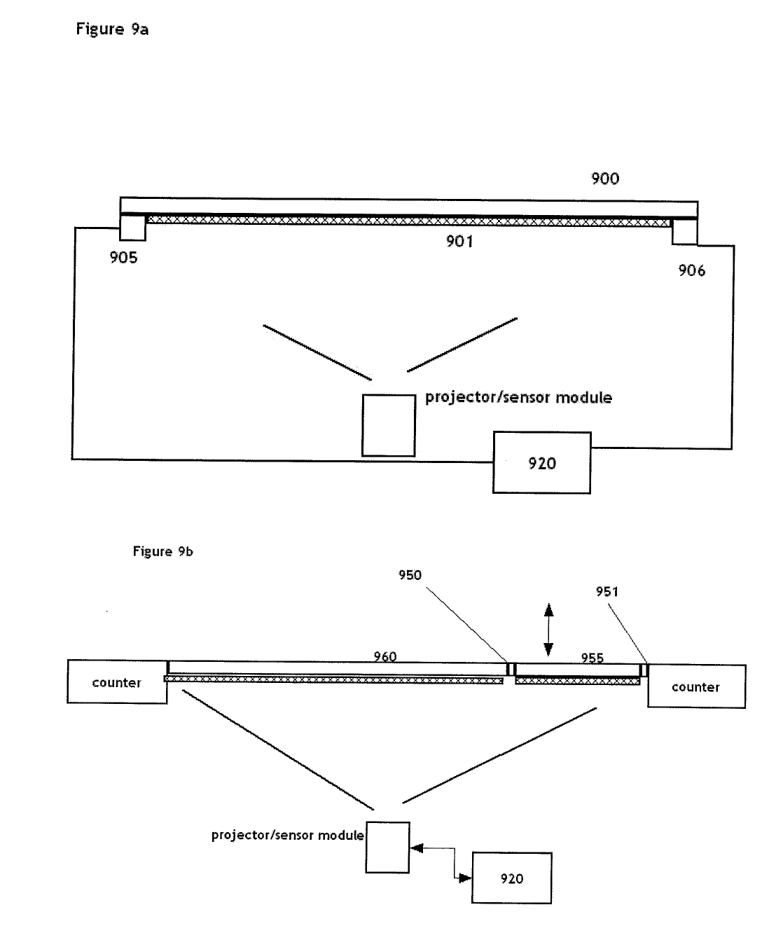

For example consider FIG. 9a, illustrating a work-board with a direct weighing capability in which the whole screen and work surface 900 or a portion thereof is also used as a weigh scale. In this case the surface 900 is for example made of impact resistant glass having 3M vikuity dispersive material 901 on its back face and is located by four supports, two of which 905 and 906 are shown in this drawing. The supports contain piezo electric sensors responsive to force, whose signal conditioned outputs are analyzed by computer 920. An output signal is provided indicative of the change in force constituted by the objects resting on the surface as compared to the situation when nothing was there (The tare condition, so to speak). This tare condition can be sensed by the sensors of the invention and whenever present, a zero reading taken for example. This system works but gets less accurate as the size of the screen grows increasing the tare weight. The transducers are under constant exercise due to the work proceeding on the surface. For this reason a small portion of the surface is more desirable, even though in this case the projection in certain zones is blocked by the supports for the portion. And to avoid debris, a seal is of use around the periphery.

An alternative method is shown in FIG. 9b. In this case two flexures 950 and 951 support a rigid transparent but diffusive weigh pan 955 of the type described above within the overall screen and work surface 960, one flexure 951 is near the side of the screen to least disrupt projected images. The weigh pan deflects with object load, and the deflection is measured, and such measurement may be using the sensor device as disclosed in copending applications, or by other means. The flexures are steel or other elastic material and can be easily chosen for the weight range desired. The problem here is debris falling in the cracks (which need a seal ring in most cases as a result), and a somewhat flimsy construction compared to the previous approach, if the surface is to withstand loads from work performed. Accordingly this portion should be used primarily if not entirely for display, or resting of objects, with no heavy forces exerted.

Another alternative is to use a portion of the screen of thin cross section, such that objects placed on it will cause it to deflect as a membrane under load. This deflection is measured by the camera as shown in other copending applications and from that, weight determined assuming deflection is proportional to force and has been pre calibrated A problem with this approach is that typical screen materials are not particularly elastic.

The invention comprehends a low cost replaceable work board in case it gets too scratched through wear such as cutting vegetables on it. When too worn one can remove it from the counter easily using known means such as screws, Velcro etc., and replace with new or refurbished ones. There is also another advantage in that the worksurface and screen can be easily cleaned, including any knobs or other controls thereon, a task not possible with an LCD or other flat panel display based control system. Furthermore, the worksurface can be sterilized, by any means to which the material of the surface is not damaged, such as hot water, antiseptic baths, nuclear radiation or the like. This is important also for commercial purposes such as hospital kitchens or other locations requiring sterile equipment.

To prolong work surface life and provide other benefits, one can use scratch resistant material such as nylon or Teflon. The screen needs to be transparent to light, and diffusing if used for rear projection. The material of member 150 can form a bulk diffuser for projection applications in some cases. A diffusive but durable screen can be formed for example by having a thin Teflon or nylon spray coated or laminated to a transparent plastic member such as Lucite.

With rear projection it is generally possible to direct light preferentially in one direction by using micro-shapes incorporated into the screen surface. One example is TRAF micro-replicated prismatic film made by 3M which can direct light at an angle toward one side or as shown in FIG. 1, both sides of an island counter. This is helpful as a person standing next to the counter is at an angle to the surface normal of the work surface. It is possible to micro form the front or rear surface to preferentially shoot the light to the sides corresponding to persons standing around the counter (in an island). Any shape workboard within reason may be provided (circular, square, rectangular, irregular, diamond, etc.), and any patterns or colors may be projected to your desire, which colors and patterns can be changed daily if you want.

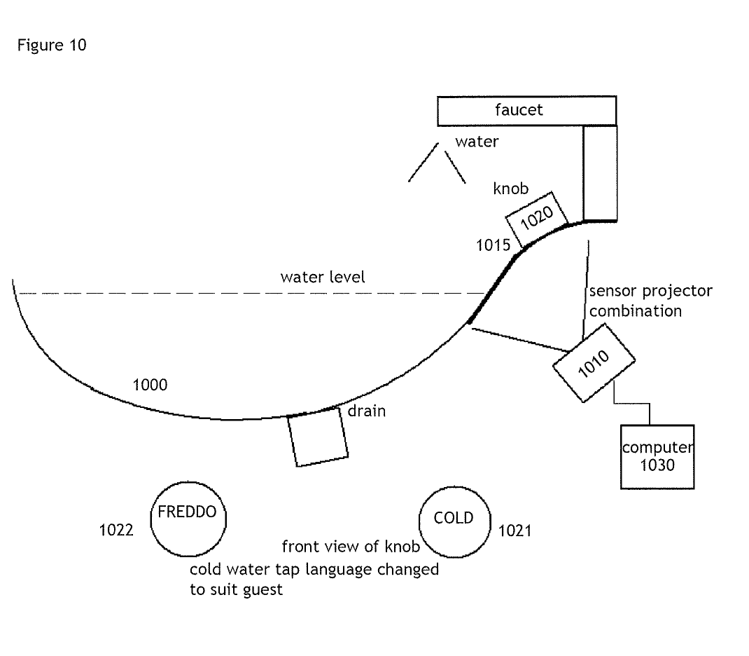

My U.S. Pat. No. 7,084,859 and the co-pending application '868 have illustrated use of my RTD invention in the bathroom shower and other locations where water is present, and can pose a danger with conventional electronics. FIG. 10 herein illustrates another application, in this case to a bathroom basin or kitchen sink fixture 1000 with a small projector sensor unit 1010 and a touch and control surface 1015 including a curved display screen and having physical control inputs, in the later case via a knob 1020, and another knob into the plane of the paper and not shown for clarity. A one knob system can also be provided to mix hot and cold if desired. Since water is controlled with valves actuated under control of computer 1030 which also controls the sensing and projection on surface 1015 (typically made of Lucite or glass with a diffusing surface in the front, or 3M vikuiti or other beaded rear projection screen material in the rear), one can automatically turn water off when the sensor/projector 1010 combination senses that the water level is too high, or it can slowly be lessened as the level approaches the set point. A conventional thermistor or other temperature sensor can be incorporated to sense water temperature and automatically control (and display) temperature set by a person using the touch surface 1015. Alternatively the control knob 1020 can for example change function to be a temperature knob if desired. The projection screen can display different languages colors etc. For example it may display either English 1021 or Italian 1022. The camera or other sensor used can also determine water level, by variation in the returned image, which can be used to turn off the water when the level exceeds a limit. Optional touch inputs on the screen can be provided as disclosed in copending applications. Such inputs can for example be used in a menu to change language functions, change maximum temperature settings, information to be displayed and other features.

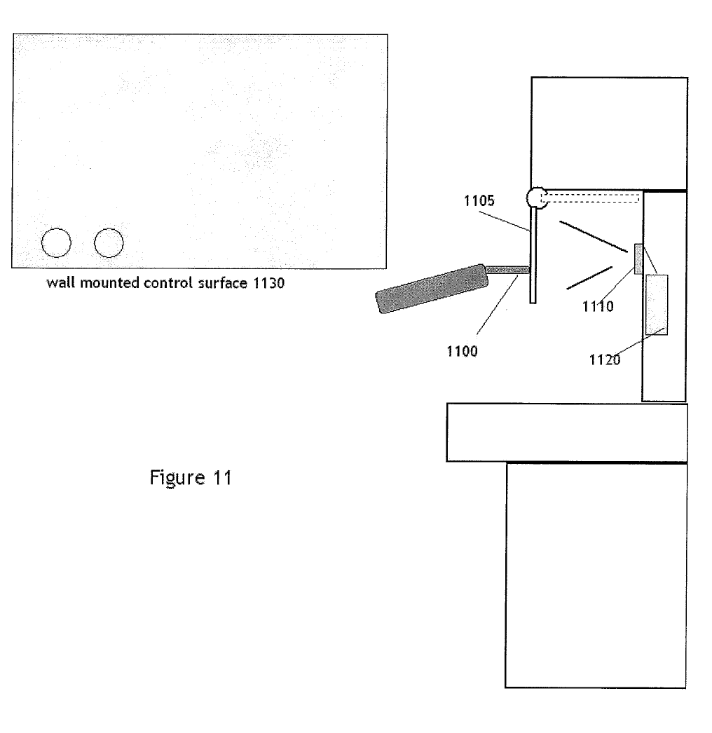

FIG. 11 illustrates a flip down cubicle desk embodiment of the invention also illustrating a wall mounted control surface like that of FIG. 2. As shown a person's finger 1100 is making a touch sensed command by touching the projection surface 1105, flipped down for operation in front of projection/sensing module 1110 connected to computer 1120.This in turn may be if desired be operated in conjunction with a wall mounted large screen device 1130 capable of using virtual or real controls to operate controlled items, such as for example factory equipment which might be located near the office desk. This flip down screen (which alternatively could flip up from the desk top) can be used for multitouch or other operations, as well as to actuate physical controls if present. The projection/sensing module may be inexpensive if cell phone projectors become widespread. The device can be used with a normal mouse or other input, and can substitute for a laptop or desk computer. Or it can be viewed as an auxiliary to a laptop, used for special touch or control operations.

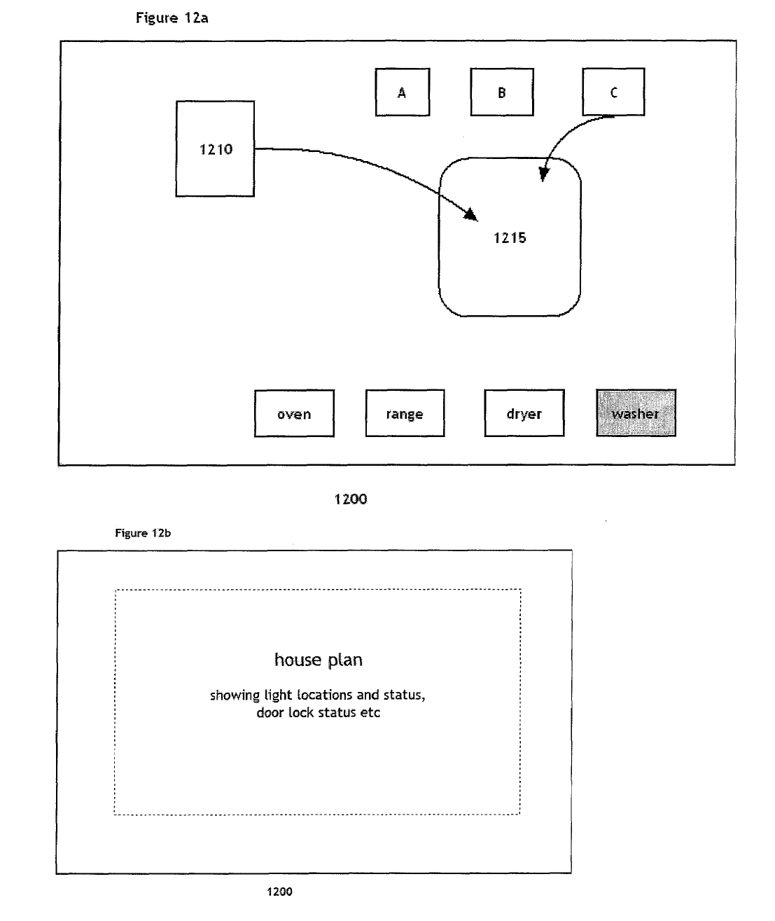

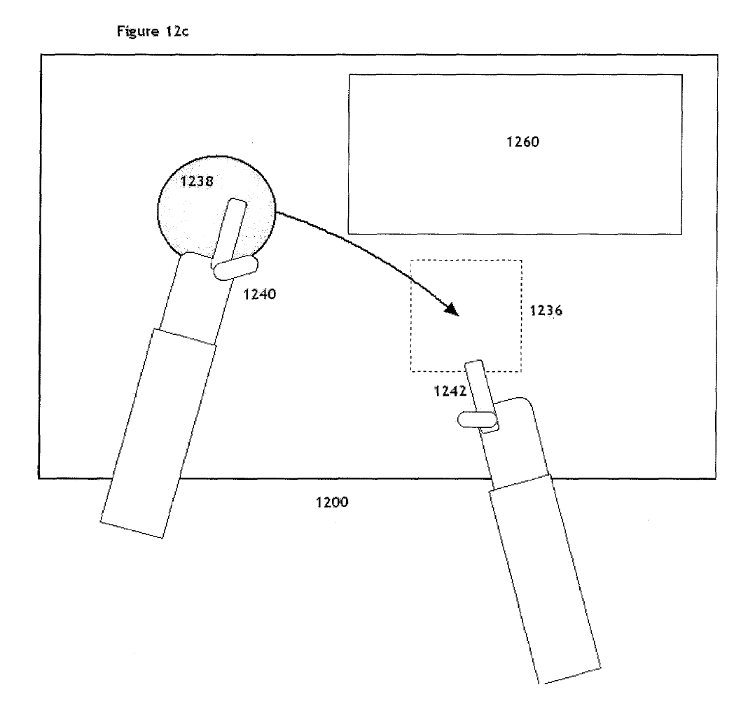

FIG. 12 further illustrates a point raised in FIG. 2a and illustrates finger gesture and other on screen inputs of use on the screen and work surface of the invention. For example FIG. 12a illustrates a work surface 1200 on which an image of clothes 1210 is moved by the users left hand (or finger thereof) onto image 1215 of the washer, in order to start the wash cycle “C” which is also dragged into the washer image 1215. The washer graphical control images are initiated for example by placing the finger of one's right hand on the icon indicating WASHER. Since the sensing is multi touch capable, the left and right hand fingers can both be operating on the screen simultaneously if desired. The points such as washer, dryer etc. where touch icons are normally displayed can if desired have small relief features to aid finding them as shown in FIG. 1c and co pending applications.

FIG. 12b illustrates a control panel 1200 with a house plan map on the screen. If suitably interfaced, lights and other services in each room can be shown and controlled from this panel using its touch sensing capability. Status changes can be by touching an item or a control icon for example near it.

FIG. 12c shows a person using their right forefinger 1242 to touch a virtual graphic of an oven, while at the same time, moving a graphic representation of a cookie, or in this case a real cookie dough mound 1238 with their left hand over to the oven graphic. In this case one might have previously recognized that cookies are to be baked, and start the oven for that temperature cycle. A recipe 1260 from the internet, from which the oven temperature might be derived, is displayed as well, if desired. The touching of the graphic 1236 with finger 1242 can be used to start the oven, or alternatively the movement of the cookie related graphic or real object 1238 to the oven graphic can be for example used to start the oven.

There is a potential need for hand gestures by a person in the kitchen, to supplement when they are not near the control surface and yet want to make a control input. The camera can sense this and use the same computer and vision program to determine the input. Hand or finger gestures in space may also be used with the invention. A camera or sensor/projector module overhead such as 130, or a side mounted camera such as shown in FIG. 1b, can be used for observing a gesture of the person, using either a body portion such as a hand finger head or the like, or using an object they might hold in their hand, like a spatula. Such gesture based control of various computer facilities has been described in co pending applications incorporated by reference herein including Ser. No. 11/186,898 and my U.S. Pat. No. 6,750,848.

In this application there are several special situations. First a camera overhead can see hand movements in front of or on the worksurface, especially if it is lit up by a display. This easy sensing is in two dimensions, the xy field of the camera. So moving ones hand from left to right thru the field could constitute for example a command, such as turn burners off, or switch control function of the screen to laundry room, or display baby room image, etc. One can use finger gestures this way as well, and there are almost an infinite variety of possibilities. But to be truly useful they should be intuitive.

As taught in co pending applications, one can also use the camera to see in more than two dimensions, particularly if something about the user or an object held for example is known. This could be feature locations which can be used to solve single camera photogrammetry equations, and can be artificial features for example on an article of clothing, or an implement such as a pan, spoon or the like.

One can also see gestures close to the screen from the rear if the screen is only mildly diffusive (e.g. a high gain rear projection screen). This can, like overhead also include seeing when you are putting something on a burner for example, and starting timing function at that point if desired.

The work board of the invention can also be used as a desk in the flat form shown, that is more or less parallel to the countertop and as has been noted in previous applications and patents. One can for example use in multi-touch approach to manipulating family photographs on its face that are projected by the projector or in another example, one can actually use the device to read documents or other data that you would put onto the screen. Since the cameras able to do that as long as the portion in which you put it is conducive to such reading. One since the work surface is interchangeable as well as being washable you could for this purpose use a diffusive work service that was flat or flat in a region, for these types of computer interaction and document reading purposes. This allows you than to use the device to read in receipts that you might pick up from a grocery store or phone bills or any other document that you might want can be read into the computer.

The work board may act as a desk for use in the kitchen, or if the device is located elsewhere, for example in a den. The particular board might be interchanged with that used as cutting board for example, to make a better surface for writing or drawing on, which drawings and handwriting can be determined by the computer and stored or transmitted as previously mentioned in co pending applications. And you can tilt the worksurface up to make it more of a writing desk. And it can be built flush into a counter or other surface, but then popped as the up when want to use in that mode, depth of field of both projection sensing can allow this

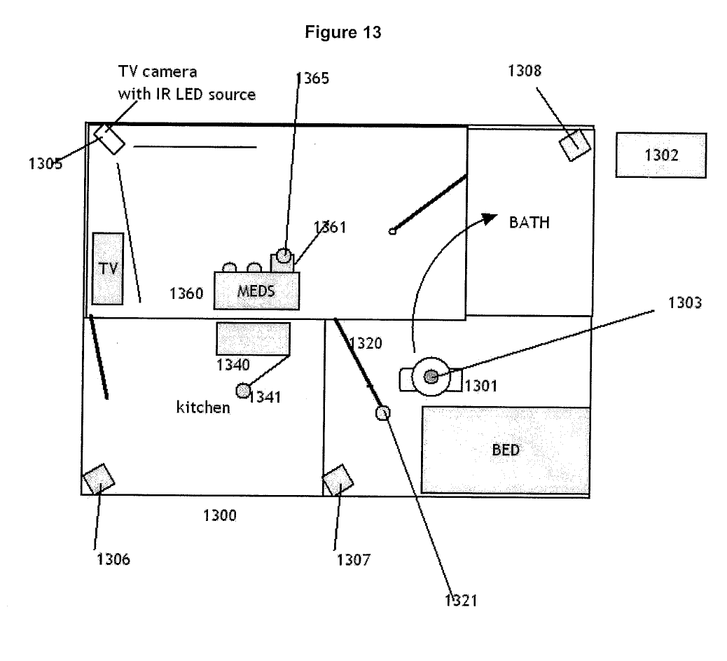

FIG. 13 illustrates another aspect of the invention useful for seniors living at home, and disabled persons and others who need some assistance in monitoring their daily life. I feel for example, that the kitchen worksurface invention above will help in this regard, by making meal preparation less difficult, especially for older persons who have not historically cooked. It also adds a degree of safety as activities in the kitchen area can be camera monitored and warnings given of dangerous conditions such as water boiling too long, heat left on and the like. Indeed, the system can include automatic shut down of burners and ovens if needed.

At this point though I would like to expand on the idea of monitoring activity in the home in general, to assist seniors and monitor their well being. In the examples now illustrated the camera system invention is used in much the same manner as disclosed above, but to monitor the location of simple near IR reflecting targets on the person in the room. (Alternatively in some cases colored targets having high contrast can also be reliably used) To a degree at least the system does not intrude on privacy as the camera is set up with an infrared filter so it cant take pictures of persons themselves due to the low light levels of all but the infrared reflection from the targets. This has many advantages, primarily in that it provides a very low cost solution to common living at home problems. For example consider small apartment 1300 with 4 rooms. A central computer, 1302, or a computer on a remote server, continually monitors the 4 (or more) cameras 1305-1308 in the 4 rooms, located so as to view the room, at least in the areas of use. In this example, the cameras are wirelessly connected to the computer 1302, though they may inexpensively be daisy chained fire-wire cameras for example, easily interfaced to the computer.

The goal is to track one or more features (typically but not necessarily high contrast artificial targets) on the person in an accurate manner in order to see, for example; falls; deviations from normal routine, such as path to the bathroom, frequency time of day; abnormal movements such as unsteady walking, head nodding too much. The cameras can also be used for security purposes. And the invention can not only see the movement of the person, but also the movement of objects within the space, such as the opening of doors, the lifting of toilet seats, the use of kitchen utensils and so forth.

As pointed out in previous referenced applications, one can have retroreflective material or highly contrasting colored material for example, around or attached to portions of one's body or objects associated with you. These include a collar around one's ankles and wrists a headband or one can also make the target material such as Scotch light 7615 into part of one's clothes for example, outlining certain areas, simply acting as decoration and so forth.

A simple application is where a person 1301 in the house is wearing a hat or some other thing like a hairpiece with a single retroreflective target 1303. This target is visible by cameras 1305, 1306, 1307 and 1308 located in the upper corners of the rooms of the apartment. When the person is not sleeping. Typically the cameras employ as well as Near IR light source (e.g. 880 nm, and not shown for clarity). The target device remains on their head, and everywhere in the house, they go. This target piece can be seen if they would suddenly fall down. The target which seen be seen to drop in the field of view, and then either perhaps not be visible at all or certainly stationary for awhile or remained stationary. This sort of us signature can be used to predict. A potential fall, and essentially sound an alert that alerts the caregiver that something may have. In this case to avoid false alarms, and having to have someone immediately come there. The TV camera changes from infrared illumination mode to visible light illumination mode and a regular image of the room is produced the first image being data for the occurrence happened. The caregiver can then look at this image and see if something bad is happening or for that matter it to assure that the person is actually in the room. The person is not in the room than other rooms can be looked at as well in this manner.

The desire for infrared illumination is to make the whole system unobtrusive to the person in the house. It also allows it to work at nighttime when one would not like any visible lights to be lit. If the camera is to be used to take visible images too, then any infrared band pass filter used on a camera has to be moved out of the way, assuming a color image is needed. If an ir image would suffice, one can just up the IR energy until a satisfactory IR exposure is made, which is sufficient to identify problems. This aspect is important too for determining if Alzheimer's patients and others suffering from dementia are not in the right place.

Retroreflective material can be used for ribbing or other decoration on clothes as well. For many seniors a pendant necklace is desirable having a call button device on it. This necklace itself can be made of a retroreflective rope or band like material at which can then be seen around the persons neck as well as from the front. And back assuming that the shirt collar does not block the view

Various types of optical signatures as a result of movement can be accurately seen and recorded in this manner. For example, one can record signatures of the normal daily activity where the person say gets up from bed and goes to the bathroom at night. This has a normal signature of movement out of the bed assuming a suitable target or clearly visible natural feature is on the person while in bed, for example as part of a pajama. The movement to the bathroom can be tracked including opening of doors which themselves can be targeted, such as door 1320 with target 1321 also able to be seen by camera 1307. Other things that can be targeted can be anything, and particularly those items depended on for daily living. For example the toilet parts, the water faucets, various utensils in the kitchen, the range, and so forth. In short, anything that might have something to do with the behavior or safety of the person and need to be monitored in the sense of potential abnormalities in that behavior causing some sort of problem The refrigerator door 1340 is another with target 1341 which can be observed by camera 1306 in the kitchen.

None of the targets have to be particularly obtrusive, as they don't have to distinctly reflect visible light. And even if they are to be used with a visible light camera, they can be small and/or decorative.

The invention is very low cost in this manner, since cameras and light sources or inexpensive and central control computer 1302 can be also used for other purposes in the home and to communicate over the Internet with the caregiver's PC, and indeed some of the machine vision processing used in 1302 to analyze the target or other images can also be used for other tasks as well. One of these was the “Postbox” or loose leaf binder approach shown in the patent application by Peter Smith and myself entitled, PERSONAL INTERFACES FOR INDEPENDENT LIVING AND HEALTH. Another potential application of virtually the same equipment is for the exercise based games above, where the sensor can monitor the persons activity while exercising.

In the above application, we give an example of a single target on a the top of the persons head. The point, for that location is it is visible by cameras overhead in the corners of the room. There are however many other potential target locations. Indeed one would likely have more than one target on the person. This is also in case of some obscuration or, the problem with one of the targets but also to allow viewing from different vantage points and to view different activities.

There are certain types of activity such as walking after getting up from sitting down for example, that can indicate certain medical problems that could be seen using the invention in this manner. Since the bed in a room can be targeted, one can also see if the person is in or near the bed, and one does not have to have a complete room image. One can also see unsteady motion of the person particularly the case if target more points on the person are targeted. It is noted that small flashing LEDs, can constitute targets too, but require battery power and are more obtrusive.

Medication dispensing unit. For those who suffer from lack of physical dexterity or impairment, and those taking multiple meds or complex med schedule there's also an application using the camera sensor to observe the taking a medication which is also a problem for many seniors in the home, particularly those who suffer from mild or moderate dementia. This is also due to the number and types of medications that they need to take at different times of the day since the computer is aware of the time of day and the camera connected to the computer can see the medication box, such as medication box 1360 including doors with easily seen targets such as door 1361 with target 1365. It is possible to determine at what time the person came over to the medicine box and which doors were opened. If the wrong door is opened and the camera is not obscured from seeing the door some sort of a sound could be made that would indicate to the person that they were picking the wrong medicine for that time of day. This is by no means a small problem, as there might be 15 different pills at different times of the day. The Invention may not be able to do everything you would like, such as actually count the number of pills at the person physically puts in the mouth. But it can at least make a start at the problem. And to a degree might be able to do this by having a door only dispense one pill at a time. So it would then have to record that if one was to take three 350 mg pills of a certain type at that time of day that the door would have to be opened and shut three times. This, the camera and computer can see and do easily. It should be noted that this system is consider a less expensive than automated medication dispensers of conventional types.

The camera in a more sophisticated machine vision version can see the person's fingers or other datum such as a target or other feature on the persons sleeve, and note that after reaching into the box, that the person put the fingers up to at least near his mouth, indicating that the medicine had been taken. Even more accurately would be to observe the person directly using an optional second camera located to view his fingers and face, if the first camera was unable to do so, as is the case of camera 1305 which is not positioned to view the face of a person taking medicine from medication box 1360.

While the invention's machine vision based camera system cannot easily measure vital signs of a person, it can be used to help remind the person go to a place in the apartment where ones temperature or pulse or other variable could be measured. And it can observe that they actually place their arm in a blood pressure monitor or other machine to have the pulse taken for example. Again this can be done easily if the person is cooperative with retro reflective targets or other high contrast features. Even normal features of the person for some of these applications can be processed economically by machine vision as it is. But for monitoring motions at night and infrared as well as for making the system simple and effective, the retro reflector's are helpful.

FAIL SAFE OPERATION. It should also be noted that the system in this form fails safe. That is to say that if one cannot see the target that is supposed to be on the person, then you basically can sound an alarm (e.g. over the internet to a caregiver) to check the image manually once again to make sure that things are okay. In other words, the system cannot be reporting satisfactory information if the target is not visible. A caregiver can override the system, a remotely by simply looking at the image and can perhaps check the infrared image as well to see why the target isn't there. For example it could be some kind of a fluke where the person had for example put a flower in their hat that covers the target.

Besides having a camera switch onto a visual in case of some sort of warning, the computer can also turn on a microphone as well to record what's going on. This also can be used to listen for heart or lung sounds, if they are discernible to microphone louts sounds of letter say, costing typical pneumonia or congestive issues probably be heard. The camera system in the same invention allows a nurse who might be on the scene to transmit a high definition wound image.

Analysis of the data taken may be totally done by automated means and in certain cases can provide an assessment of the function of the person. For example one sort of an assessment can be the time taken to get up from an armchair which can be determined if the sensing system can see a datum on the person which moves upward indicative of the function. Undue slowness, hesitancy, abnormal movements of the trunk or upper limbs staggering stumbling—all of these things can be built into an assessment program for future determination of what is possible for the patient, as well as to simple monitor that nothing undue happens. One can also use the invention to monitor dexterity and reaction time in chores or another activity done repetitively each day.

The food preparation aspect of this invention has been described with respect to home use. However many aspects of it can be used in restaurant kitchens and other commercial installations. In addition while major appliances have been largely discussed, the control center represented by the work board can control smaller appliances as well if such are suitable able to communicate. Examples would be mixers, microwaves, waffle irons, etc. They could also be electric services outside the kitchen, for example a garage door, lights or cameras in any part of the house and the like.

It is also noted in the example of FIG. 12, that one can play games on the work surface too. As disclosed in my copending applications and referenced inventions, for example Ser. Nos. 10/934,762 and 11/980,722 classical games can be played also with actual pieces, for example by projecting a checkerboard on the surface and sensing checkerboard pieces of red or black, or chess pieces of white or black. You can even sense common kitchen items and store them as pieces. For example you could teach the system that a salt shaker (whose image was obtained and stored say by a camera included within the optical projector and sensor member 105 and recognized using a computer algorithm vision program such as Matrox MIL), was a bishop to be used in a chess game. When the camera subsequently acquires the salt shaker image it is then identified as one persons bishop, and so on. Or you may play against the computer, which would generate virtual graphics on the screen for its moves. All virtual generated games can be played as well. This game activity ability allows the kitchen counter after meal times, to serve double duty as a game table, to play virtual graphic presented games also or alternatively using real objects such as electro-optically or otherwise sensed shuffleboard pucks as shown in my copending applications.

The following embodiments discuss additional applications to the home and appliances. It should be noted that there are a wide variety of information display and control interaction possibilities made possible by the disclosures in this and my copending applications, and previous patents

For example it is now possible to economically (e.g. for $1000 dollars or less) front project information at low cost using led based displays in the range of several hundred lumens or more. This is ample for viewing of large images in most home conditions. The cost depends on the total lumens and the requirement for wide angle lenses if required. Lenses with wide angle throw ratios less than 0.6 are typically more expensive to produce for example than those greater than 0.6, and more computer image correction is needed as well to deal with distortion and other factors resulting.

One can front project onto a screen on a counter top, or forming part of an appliance such as a fridge door, or washer top. One can alternatively front project onto a screen which can be motorized to vertically rise out of a stove, or sink. The principal requirement for the utility of such projection is that the surface projected on be diffusive and reflective enough to suit the application, and that the surface generally be free of objects which would interrupt the projected image. However in some cases such objects, including hands and fingers may be useful for signalling or control purposes. Besides projecting information for information entertainment and control purposes, the apparatus employed in the invention can sense knobs or switches or other control features on a screen using a camera (or other electro optical sensor). This camera may be located in the projector housing if desired, or located elsewhere, for example on the side to provide a view in the direction of projection rather than perpendicular to it. Examples of such front projection will be shown below in several figures.

Besides providing useful information and control features, there is also a need to reduce unnecessary repetitive labor in the kitchen, particularly in regarding to stirring and mixing tasks that consume time that could better be spent on other activities. Stirring also creates in some cases a potential safety hazard. In addition many other safety related situations can exist on the range top, which can be aided by application of machine vision technology.

FIG. 14 illustrates an embodiment of the invention using one or more cameras such as 1401 in a range hood 1405 interfaced to a computer such as computer 1410 (via wires or wireless) which may be stand alone or built into an appliance such as a range 1415. The camera and computer system can be used to monitor activity on the stove top and can also be used to control a robot such as 1420 that can be used for stirring matter in pots such as 1425 on the stove top. The mixing device robot can also be turned in the other direction to an adjacent counter and drawer unit 1416 and used as a mixer of drinks or other things, for example by lowering it into jug 1417. Lighting can be provided using room lights or using specialized sources, such as IR LED light source 403 operating at a wavelength of 820 nm for example. If such light sources are used, the camera can contain a band pass filter which passes only this wavelength, making the system relatively immune to room light variation. This is useful when special retroreflective targets for example are used (see for example my copending applications) which may be on objects such as robot arm 1420 for example. One can use a 3D camera if desired such as a time of flight lidar type made by Canesta corporation, or use a stereo camera pair such as 1407 and 1408 on either side of the range with to get range.

This camera system with associated computer 1410 can be used to determine the presence of boiling water in a pan, and alert a user to that situation (or the lack thereof, or various gradations of boiling). It can see using known machine vision algorithms in the Matrox MIL vision library running on a PC computer 1410 (or other suitable dedicated machine vision system such as that of Cognex corp.) Panhandle location on the range, and the presence of objects which shouldn't be there, such as a child's arm, and sound an alarm, such as with loudspeaker 1412 connected to computer 1410. Such an alarm could sound also when the panhandle 1431 was detected to be outside the periphery of the range, and thus possibly hit by a passerby, or grabbed by a small child. The speaker can also be used for entertainment or information associated with projector 1452 used to project onto a suitably diffusive surface of the range, or an alternative or optional projector (not shown for clarity) used to project onto screen 1460 (dotted lines) which can be pulled down, motorized to come down on command, or built into the range hood. As disclosed in FIG. 10 of my copending Ser. No. 11/980,722 application and others, knob 1461 (dotted lines) can for example be sensed as to the location of an indicator dot 1465 by a camera or other electro optical sensor in the projector housing or elsewhere.

The camera and computer based machine vision system can also be used to control a robot 1420 that can be used for stirring. This robot can be located in the stove itself and pulled up and lowered down into the pan 1425 whose contents are to be stirred. Optionally it can also be turned in the other direction to an adjacent counter and used as a mixer as shown in dotted lines. While shown here with a mixing paddle 1421 rotating around an axis 1423 driven by a motor not shown for clarity. It may be desirable to have the paddle or other mixing element driven in an eccentric motion or a FIG. 8 motion or other motion mechanically achievable at affordable cost.

There exists also a need for devices which can improve safety of operation of home systems, particularly ovens/ranges. This is particularly the case as more seniors and disabled persons are encouraged to live at home. For those who are sight impaired or under stress, there is also a need for easier to see, easier to operate and less distracting controls

FIG. 15 illustrates a version of FIG. 2a in which an iPhone 1510 or other smart phone is connected to the invention by as taught in FIG. 1, and its screen image 1500 is mapped directly on to work surface (optionally in landscape mode 1505) and the phone and its functions controlled directly by touching the work surface. In this case the iPhone functions themselves can be controlled as well as any special functions activated when the device is plugged in, as into slot 280, or connected by other means such as Bluetooth, USB, WIFI, or the like. The iPhone in this case has been shown to be plugged into a slot in the counter.

A variant of FIG. 15 wherein control features such as control of playlist scrolling may be performed with physical controls on the work surface, in the manner of the switch 156 or knob 157 of FIG. 1 c.

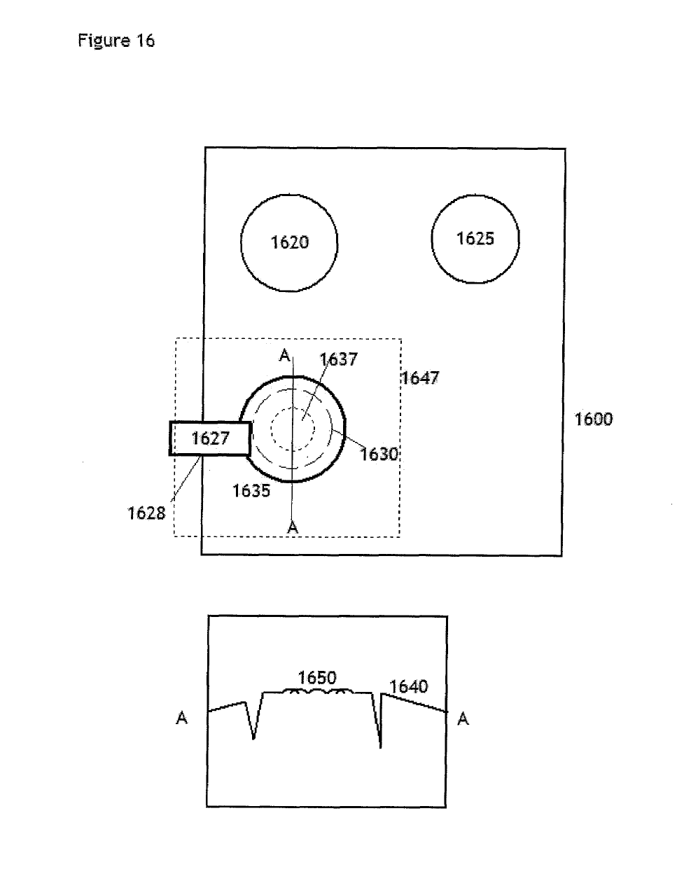

FIG. 16 further illustrates sensing techniques associated with the apparatus of FIG. 14. Consider the image 1600 of the stove top and its environs captured by camera 1401 such as a CMOS webcam made by Logitech Corp. having 1.3 million pixels. This camera can acquire the image at least 30 times a second assuming sufficient illumination, which can be provided as described by Leds such as 1403 if room lighting is not sufficient.

In a first application example, the camera is used for determining the state of boiling in a pan on one or more range burners whose images are 1620, 1625 and 1630 shown in dotted lines, as covered by pan 1635. If the stove control and camera are controlled by a common computer system such as 1410, the camera may be used to look at the image region of a burner when that burner is on. A pan image thereon is detected and this indicates it may need to be monitored for boiling conditions. Also sensed (and connected to an alarm function, such as audibly through loudspeaker 1412) is a condition that the burner is on, but no pan is on top of it. This is undesirable in general, and certainly if too much time has passed.

The second thing sensed is the water or other liquid in the pan, and its state of boiling. This can be determined by looking at the image region 1637 in the central area of the burner where all pans are placed such as 1650 and analyzing the effect of bubbles in the water on the image. The more high spatial frequency change in the image, the more bubbles and the higher the state of boiling. For example, image trace 1640 of a line AA across the image of a central region of a camera field region of interest (ROI) 1647 on burner 1630 where a pan image 1635 is present has high frequency noise 1650 on it indicative of boiling, whereas image trace 1645 does not. Such change can alternatively or in addition be analyzed in a time based manner by continually subtracting images of the pan liquid in the region

The simplest action in the boiling water monitor is to sound a audio or visual alarm that the water is boiling. However, when automatically connected to the range, it can actually turn the heat down in various manners, for example to decrease to a low boiling state, or even to turn off the burner entirely. Conversely if boiling is supposed to happen and doesn't, it can also signal an alarm.

It is noted too that the camera may have its own microcomputer associated with it, in order to process images and sound alarms, independently of the range controls. In this case the three burner regions are constantly looked at and a pan image determined, if any is present. This is dark ring on generally reflective background. If a pan image is there, boiling conditions are sensed in that pan, as one processing example.

The other principal use of the camera system is safety. The primary issues here are to sense for unusual conditions on the stove, such as persons entering the stove area, burners on but with no pan, and pans such as 1635 with handles dangerously sticking over the edge of the range, where they could be hit by small children.

The image of the region of interest of the stove top and a zone just outside it is captured. As shown also in the image 1600 the pan handle sticking over the edge can be determined by analysis of the image, where the handle image 1627 clearly bisects the image of the edge of the range 1628.

A static situation existing for more than a fraction of a minute such as the pan handle is easy to determine and generally separable from normal motion around the stove in food preparation activities. More difficult to determine without false alarms is if something enters or leaves the space which shouldn't be there. One method of simply dealing with this is to set an alarm when the cook leaves the area of the range. Then any object entering the periphery of the stove 1600 image can be treated as reason for alarm.

A second method also relatively simple, is to say that objects larger than a certain value can't be present for any significant length of time in the region of the stove. This could also exclude generally circular objects, such as pans. Objects larger than arms which are not round in nature could for example cause an alarm. A third method is to look for certain movements, such as stirring and exclude those from alarm. A fourth way is to look for color, particularly flesh color, using the color sensing ability of the camera. The exact way such an alarm would be set up generally depends on what is expected in the normal course of activity, how old children are in the home, and the habits of the cook. If all pans and the stove top were not flesh color, it makes it easier to discern the presence of a person near the stove and burners.

FIG. 17 illustrates a rear projection embodiment for stove control, and miscellaneous entertainment. In this example several novel aspects are illustrated, in this case relative to control and use of a stove and range 1720. The rear projection engine 1700 consisting of a LED projector with wide angle lens and an associated sensing camera and display and device control computer as taught in copending applications is up in or near the range hood 1701 (or alternative microwave device), in a cool area as I have taught in my copending applications for other purposes. On the rear projection screen portion 1710 is the controls, in this case familiar knobs and switches such as knob 1711. The controls can be physical controls (also made of heat resistant material, which can be opaque even if projection thru them is not needed. The screen is pyrex or other transparent material capable of withstanding the heat from the burners and oven. Control can also be effected by touch or gesture as taught elsewhere and in copending applications. Internet or other data connection 1715 allows recipes, instructions and social interaction via full size images of famous chefs, movie stars or any other desired scenes, video or still. An optional camera 1740 to determine actions of the person as discussed below may be included as well.

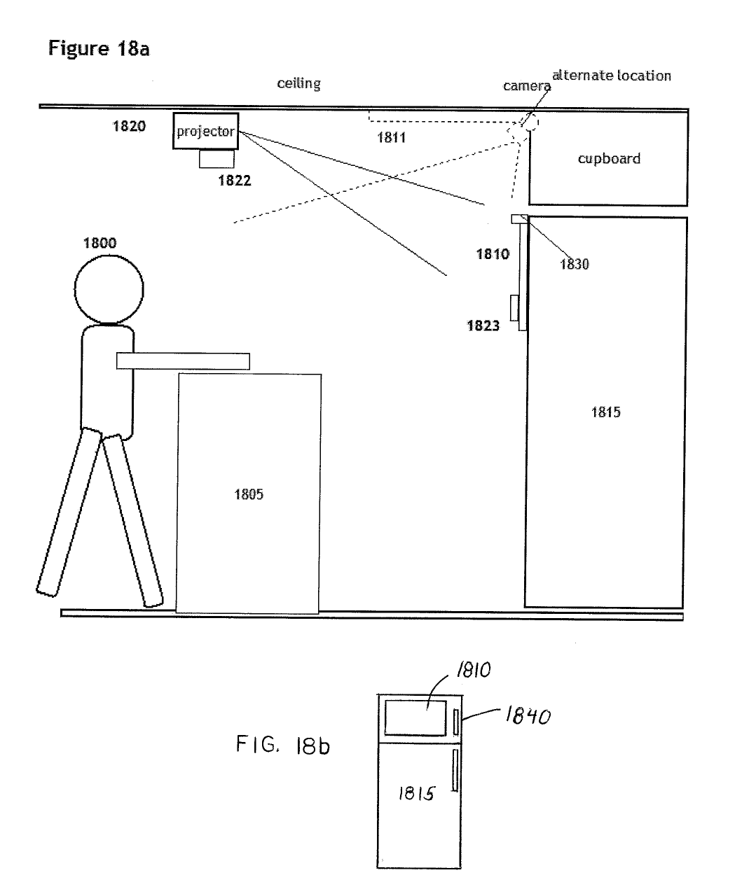

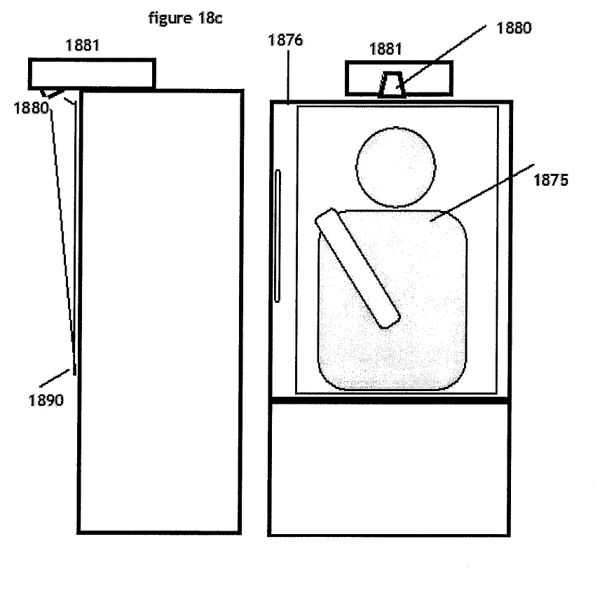

FIG. 18a is a front projection embodiment including sensing of characteristics or actions of the person or persons in the kitchen, in which a person 1800 is working at a island type counter 1805, and a screen 1810 displaying preferably life size images is provided on the top freezer portion of a fridge 1815.

The overhead video projector 1820 which can be used to project TV images, recipes from the internet and other information such as described elsewhere in this application. A camera 1822 attached in this case to the projector (or collocated with it) and a computer controlling the projector (not shown for clarity) senses a control such as knob 1812 on the face of fridge 1801. Knobs and other physical controls, and touch see as in FIG. 10 and other figures of copending applications such as Ser. No. 11/980,722.

Further illustrated is a camera 1830 looking outward at a person or persons in the kitchen. A head, hand or face gesture performed by person 1800 can be sensed by this camera, and after its image is processed to determine the gesture, can be used to control the TV image of overhead projector 1820. An alternate fold down screen 1811 is also illustrated, where it is not desired to have the screen on the fridge door. This screen can be above the fridge, or be a large version covering fridge and cupboard above.

In this embodiment gesture and voice recognition is used to communicate with a camera located in the range hood or in another location. In addition other characteristics of the person or persons in the kitchen can also be sensed and used as input to a program controlling the display, loudspeakers, appliances or other apparatus. Such characteristics can be the presence of a smile on their face, the identity of the person, the utensil such as a spatula or mixing bowl the person has in their hand and the like. Specialized easy to detect objects can be used as well, such as a flash card with special graphics or colors on it. This can make a robust signaling and control system without requiring substantial computer processing. However it is noted that typically the background is constant when viewed by camera 1822, or less so camera 1830. Thus a subtraction of images with and without the signaling item, should make it easier to discern.

FIG. 18b is a front view facing the fridge showing the freezer section 1840 on top of fridge 1815, which is provided with screen 1810. This screen can be permanent or temporary and removable as desired.

FIG. 18c is another fridge embodiment shown in front and side view. In this case it employs a screen 1890 on the door 1876 of bottom freezer type fridge allowing a quasi-full length substantially lifelike image 1875 to be displayed on the fridge door using projector 1880 (with optional electro optical sensor unit if desired) in mount 1881. While the projector could be ceiling mounted, in this case the projector is mounted to the top of the fridge, and projects obliquely onto the screen surface on the front of the fridge door. In some alternative cases such a projector could be side mounted or wall mounted, and obliquely projected sideways onto the screen.

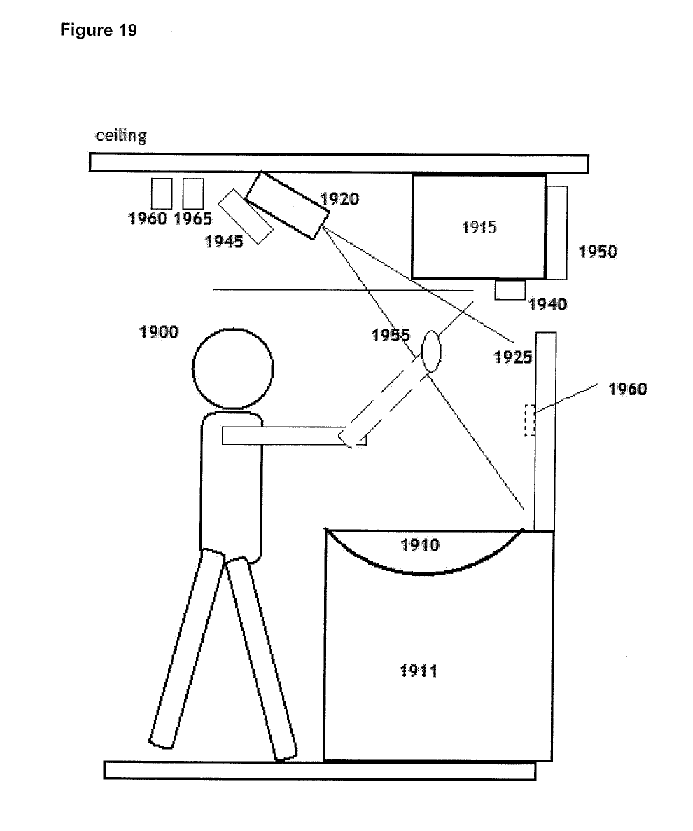

FIG. 19 now further illustrates human interaction in an embodiment employing a front projection display behind a sink in the kitchen, bath, laundry or other location at which a person may be working. As shown, person 1900 working at a kitchen sink 1910 in a counter 1911. Overhead there may or may not be a cupboard 1915, though there is generally at least a cupboard above and to one side or other. A projector 1920 projects information onto screen 1925 as in the embodiment of FIG. 18 above, and integral camera or other sensing capability can sense control locations on the screen if desired, for example to control associated equipment nearby such as a dishwasher, garbage disposal or trash compactor. Similarly too, data can be manipulated or displayed, and other activities in the home monitored or controlled as also described above.

Also illustrated are added control modes, and the unique social interaction aspect of the invention. For such control, a camera 1940 is provided attached to the cupboard as shown. Alternatively or in addition a camera 1945 can be associated with the projector as noted, which camera might also view the person as well as objects on the screen. The cameras and projector are connected to control computer 1950 with wires not shown, or wirelessly. The camera or cameras can be either a 2d or 3d type. Or a combination of the two. Auxiliary light sources such as IR Leds can be provided as desired to aid the detection of signals by either or both the cameras which may be employed.

An advantage as noted earlier is that the screen of the invention can operate successfully in this environment, without electrical hazard. The screen can be splashed without damage, and even take reasonable hits with pan handles, silverware, etc.

As noted above, it is a goal of the invention to enhance the social aspects of cooking and kitchen activity. Having life size images enhances the feeling of interaction with persons whose images are displayed, be they family members, movie stars, famous chefs or even pets. This interaction can as noted above be by gestures or voice (via microphone 1960 and voice recognition software), and the person whose image is displayed can in turn talk to the user via a loud speaker such as 1965. The images displayed can be live, via Skype TV for example to the computer 1950 driving projector 1920 and interfaced to loudspeaker, internet and microphone as desired.

Besides the sensing of physical control locations such as knob rotational positions, there are two main additional uses of the cameras of this embodiment. The first is to see human gestures or control objects, in order to cause some action, such as changing a TV channel of the projector, or controlling a stove to turn off a burner. For example, a simple case is if person 1900 wants to indicate a projected icon box 1960 on the screen 1925 (shown in dotted lines). In this example they just raise their hand 1955 until it blocks the projection to that box, which blocked condition is sensed by camera 1945 which senses the absence of the projected box. As long as the choices are relatively few such that obscuration doesn't happen, this works well. It is noted that if the hand 1955 is highly visible, that the hand itself, or an object in it can be sensed. But the person has no reference as to what that means, unless it is a movement gesture in space such as waving ones hand in an S motion say. This movement can be sensed by camera 1940 or camera 1945 for example. Given the problem doing that from a human interaction point of view, it seems better to just block things on the screen. A criteria can be the top most projected image graphic blocked is the answer, that is in the vertical direction of the drawing. This assumes the person is approaching from the bottom of the screen, which is actually (and helpfully) in the in-out or z direction due to the angle of projection in this instance. It would be less so, if the projector was projecting at a high oblique, like FIG. 18.

One can also use the camera 1945 or 1940 to observe objects the person might hold up to indicate a control function. This can be portions of the person, such as a head, hand or finger, or it can be something for example held in the hand. For example, if the computer recognizes that the person is waving a spoon, that might be a programmed indication to turn on the TV projection.

In addition to control activities, the camera and associated machine vision programs in computer 1950 can also be used to sense other things as well, for example the state of the person or persons in the kitchen (or other room, if the invention is employed there). Such states sensed could be if the person is smiling or frowning, or the like. If the person does an action, like nod their head, turn their head or blow a kiss, this may be sensed. A clothing object can be sensed, like a design on a dress, or the type of clothing, such as a rubber glove or apron.

For social interaction. The system can look at the person this way and a program probably in real time from the internet source, can comment on their dress or their attire, to see if a friend is present with them to and allow the system to be interactive by talking through a loudspeaker and excepting information from them through a microphone and a voice recognition program. The computer can be on site that can be Internet connected to something elsewhere as well. This capability allows one to have interactive video sessions while doing dishes, talking to someone who is either real (such as a family member whose image is projected on the screen) or in some canned or animated video experience or game.

Some sinks have a window over them. If a window (or mirror in the bathroom case) is present which it is desired to view out of, the screen may be moved out of the way, for example by folding it up, or sliding it down into a counter, even by motorization. It is also possible to provide a window or mirror, which may programmably diffuse light. The device if located over a bathroom sink, can be used not only for information, but to provide camera images of you for example from views to the back and side to aid various activities. Since most people don't have windows over their sink, the visual image displayed may be of outdoor scenes to simulate same. Such an image may be provided by an LCD or other display, not just a projector. But it needs to withstand the water environment and this is very risky for most flat panel displays today.

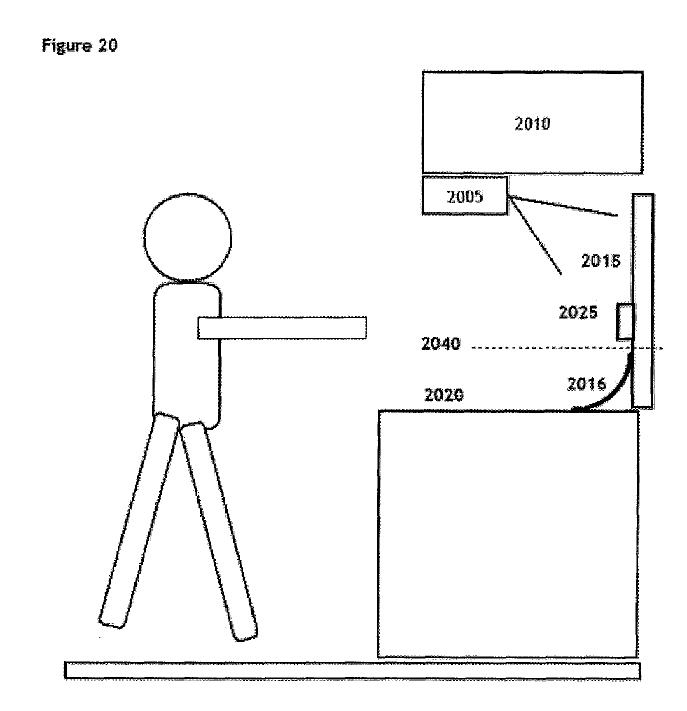

FIG. 20 illustrates a front projection arrangement for stove and/or microwave control, miscellaneous entertainment, and other uses. A projector and integral computer and display driver 2005 is mounted to the bottom of illustrates a microwave oven 2010 and projects to a screen 2015 on the rear of a range 2020. This device may be interfaced to the Internet or other appliances and services in the home as disclosed above. The screen in this example has a curved lower section 2016 at the bottom. Information such as the location of knob 2025 can be sensed using a integral or separate camera for sensing or a sensing type projector as disclosed in copending applications. In this example, the projector is built into the microwave, but it can be located separately if no microwave is used, or if it is desired, for example to project from the side or from the ceiling or below a cupboard. If heat is an problem the projector can be located at the side or top of the microwave, and the image optically conveyed to the location of a projection window. It is noted that the microwave can also be equipped with cameras in the manner of FIG. 14 to control robots, and provide for safety of operation and other features.

The projection surface of the screen can be of heat resistant material which may be easily cleaned such that splatter and the like can be removed quickly. This material should also scatter light sufficiently to act as a screen for viewing. A satisfactory surface is sandblasted reflective glass or steel with high temperature paint. Knobs and controls should be located above the level of expected pans (dotted line 2040) and away from the range surface 2020, if they are to be operated during cooking.

FIG. 21 is a diagram of networked appliances and other peripheral interfaces in which software in the main control (in this case located in a kitchen counter) not only interfaces to the appliances, but controls details of their operation, which details and other personal features can be changed in software during the products life, using downloads from various sources.

For example one can treat the control of a washer as a peripheral to a central control surface such as illustrated in FIG. 21. Another such peripheral interface is the “cushion” device described in my application Ser. No. 11/852,690 which is built in a similar manner to many of the embodiments herein, though smaller. Such peripheral interfaces can function as TV remotes, and to remotely control all the appliances for example.

One of the features of a projection screen is that it can be moved out of the way. And also that the very presence of it is out of the way in terms of counter space and that is attached to the ceiling or in front of a microwave or whatever the projector is on the ceiling and you don't have to have anything down on the ground. This is prime real estate.

With the invention, you don't have to see inside the microwave like today in order to monitor cooking progress. The projector itself (or other display which one might use, such as a lcd monitor) may project an image to show you what's inside the microwave, via a camera placed inside the microwave to look at the material there. This camera image can be remote-ed to other locations too, such as the main control panel, or another room. This would allow you to have a blank door, which could act as a projection screen, in a manner similar to the screen on the fridge door of FIG. 18. This has safety advantages in the eyes of some people In addition; the sensing of fingers and control positions on the front of the microwave in this location can be performed in order to control the microwave or other devices.

It should be noted that the screen could pull down in front of a microwave or on a cabinet or it could swing down. It could also carry a camera with it. So the camera might only be engaged when the projector screen was down for example.

For some applications desirable that food or person be displayed approximately life size face upper body to give realism. Screen allows this without using up too much room Big feature is that is out of the way, if use projector, or put on front of fridge or microwave. A front projection screen can easily be moved out of the way and you don't have to have anything on the counter prime real estate. The projector can be used as an HDTV as just as now. The invention can be used for interactive recipes interacting and the programming can be used to keep the person in the kitchen company, to speak, helping the person cook by voicing or showing how to make certain meals and so forth. The person can introduce their friends to the system and the face-tracking program in the computer can tell who is who if that aids the interactivity programming. This programming can be generate the projected images using video clips from stored responses (lets say of a movie star, to the movements, clothing, or words said by a person in the kitchen, for example). Or it can be more interactive, though less realistic, if the character(s) on the screen display are virtual and 3D graphically generated.

The invention as disclosed is useful for sight impaired persons who may wish to work in their kitchen or use their bath, but have vision which does not allow use of normal information sources such as markings on devices, and the like. The invention allows the information to be made much larger or brighter for a given control function for example.

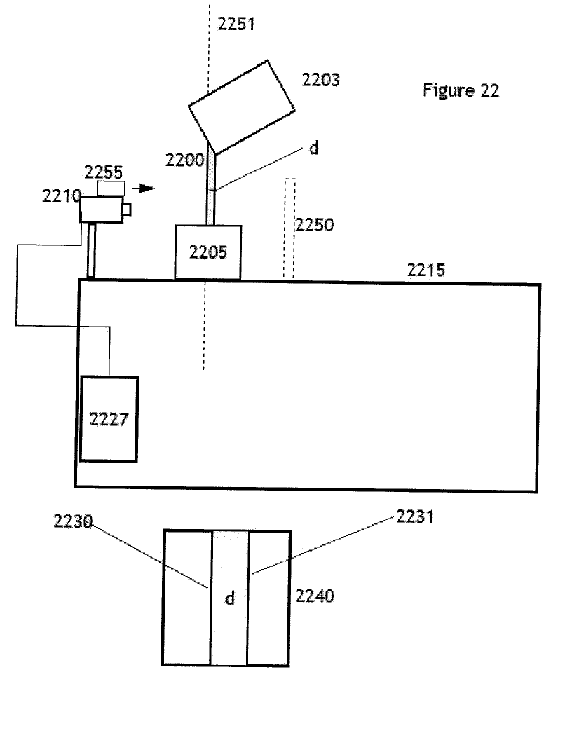

FIG. 22 illustrates liquid or material exchange determination by monitoring of dynamic pouring FIG. 22 illustrates a system for determining the liquid or granular material 2200 poured from a container 2203 into a cup 2205. Alternatively to pouring, the liquid or other material might be discharged from a faucet into a cup for example. The pouring material, in this case water, monitored by camera 2210 (and positioned on work surface 2215 such as camera 147 in FIG. 1b) connected to a computer 2227. The container is for best results positioned in a region marked to be in the central region of the cameras image field. Machine vision program routines such as Matrox MIL running in the computer can determine dynamically monitoring the effective cross section dimension d of the material as poured, determining the average cross sectional area to a given point in time during the pour (or after) and multiplying by the time the pour to that time point. This allows a calculation of the volume poured, making an assumption that the cross section is reasonably of known shape, such as round, in which case the cross section area is pi times the square of 0.5 d. If the cross section dimension d varies during the pour, the total integral of all d values is used.

In this simple example a camera 2210 determines d in one view only, by obtaining information as to the edge locations 2230 and 2231 in image 2240 obtained by camera 2210. This image processing usually can be done in ordinary room lighting with modern PC computers. However to assure a good image, the edge location images may be made very distinct when used with a retroreflector such as 2250 behind the pour location 2251 and on axis led illumination 2255. For more accuracy, two cameras may be used at right angles to each other to get the cross section dimension in both planes, and both sets of data used to calculate an average cross section, which could be oblong shaped, for example. It is noted that a system can learn typical cross sections by simply running a pour of known amount, and entering the material poured into the computer. This assumes that the pour is relatively consistent in height from the work surface and other variables. General tables of values for given materials can also be used to form a look up table within the computer. When a pouring operation has poured enough material to match a preset limit an instruction can be given to stop the pour. This would likely be in two stages, a slow down stage and then a stop. This instruction can be audible or visual for example. An approximate weight of poured material can be calculated if the computer is instructed as to what the material is, from which a density can be looked up and multiplied by the volume being poured. In this case a weight stop alarm can be made.

FIG. 23 illustrates a projector based control panel 2300 of the invention containing a diffusing screen portion 2301 suitable for automobile center stack or appliance, or other application having conventional knobs and switches, laid out similarly to some embodiments of my co pending applications, such as FIG. 6 in Ser. No. 11/045,131. The screen and control surface 2300 is shaped to envelop a substantial portion of the two knobs 2310 and 2315 shown, as well as the pushbutton switch bank 2322. In this manner the labels and other information can be changed programmably with respect to said knobs and switches, while the design of the latter is conventional. Note the use of mask member in order to block some projection light and provide a uniform annular region around the knob. The surface 2300 may also be curvilinear over at least a portion of its surface as pointed out elsewhere and in copending applications.

The knob 2315 is turns a shaft 2358 of a rotary encoder 2360, this encoder is attached by adhesive 2365 to member 2300 and/or alternative support member 2370 (dotted lines). The readout and signal conditioning connections to the encoder can be provided in any way not obscuring the projection of light from 2305 to screen 2301.

An indicator portion of the knob may printed on the knob face such as dot 2350, or it may extend as in dotted lines 2355 to overlap the display front surface as shown, to form a pointer at any data projected on the screen such a label or graphic. Alternatively the pointer may be virtually projected onto the screen, to correspond to detected knob circumferential location. As another alternative, it may be projected onto the knob face itself, for those embodiments in which the knob has a display member, such as a projection screen on its face. It is generally desirable to use a knob potentiometer or encoder readout that is a shallow as practicable so as to not obscure data on the screen—especially If the knob or switch is not located at the extremes of the projector angles as shown in the side view of section AA. In some cases it may be desirable to have a mask 2380 such that stray projection light or diffuser effects to not make a displeasing image around the knob. Alternatively or in addition, one can use a Fresnel lens as shown in copending applications to substantially collimate projector image for projection past the knobs and switches (or other physical controls) and onto the screen. This will now be illustrated together with two other knob mounting methods

An alternative automotive center stack arrangement is shown in FIG. 24, in which case two knobs are substantially wholly within the confines of the control surface member, which has simply been cut out to allow them to be in place. A control surface member 2400 provided with diffuser 2405 is projected on by projector 2410 controlled by computer 2014 whose diverging output is collimated by fresnel lens 2412. The member 2400 has on it mounted two knobs 2420 and 2450. In one case a hole is provided in the member 2400 which allows the knob 2420 to be attached using a threaded nut 2421 which threads onto shaft housing 2424 attached to rotary encoder 2430. In the other case, knob 2450 rotates on an encoding member 2451 mounted to the front of the member 2400, and thus does not require a hole to be made therein. However this generally requires the wires to the encoder to be either transparent conductors or hidden in some way under trim mouldings or the like. An optional opaque mask 2460 may be employed to block projected light from being seen. The electrical connections of knob rotational position sensors 2430 and 2451 to computer 2414 are not shown for clarity.

In the example of FIG. 24, three switches, in this case non-contact types such as capacitive switches 2483, 2485 and 2486 sensing finger proximity are provided to switch the function of the control panel from one appliance to another, under the control of computer 2014. These switches are operated using electronic circuit connections, for example with transparent conductors on member 2400. The capacitive (or other types) of switches can be changed in their function just as can the function of the knobs. For example, consider the use of auxiliary switch 2490 which is used to change the function of the three switches from the appliance selection state, to a selection device for other functions, for example TV, Audio System, and Internet Camera interaction. In these new states, the function of one or both of the knobs can also be changed. For example knob 2450 can become a tuner knob for a TV station selection, while knob 2420 could be in this example permit playlist selection scrolling of audio files remotely stored. In both cases it is assumed that suitable interface and communication facilities are provided.

If an off axis Fresnel lens is used, light from the projector may approach at an oblique angle to the control surface thus decreasing the depth of the device. See also my copending applications. Note that a pulsing member such as solenoid 2494 can be pulsed to send a force signal F into the member 2400 under command of computer 2414 to indicate various actions or states of the switches or knobs shown, as disclosed in copending applications While the knobs switches or other units can be generally mounted to the control surface, they do not have to be.

It should be noted that the screens of the invention herein, particularly those in the vertical plane such as shown in FIG. 18, can be used for aiding exercise and rehabilitation as disclosed in my copending application Ser. No. 12/358,404. Simple and low cost sensing techniques disclosed therein using webcams or other single cameras for input of video game commands may be used also in this case for input of commands to control various home functions.

While the invention has been described in connection with numerous embodiments, it is to be understood that the specific mechanisms and techniques that have been described are merely illustrative of the principles of the invention, and numerous modifications may be made to the methods and apparatus described without departing from the spirit and scope of the invention.

1. Control system for at least one home apparatus comprising;
a video image projector;
a member having a surface on which an image is projected; and
computer means for sensing a control signal relating to said projected image on said surface

2. Apparatus according to claim 1 wherein said apparatus is a household appliance.

3. Apparatus according to claim 1 wherein work is performed on said member surface.

4. Apparatus according to claim I wherein at least a portion of said surface is curvilinear.

5. Apparatus according to claim 1 further including a TV Camera for generating said control signal.

6. Apparatus according to claim 1 further including a physical control member attached to said surface.

7. Apparatus according to claim 1 further including means to change the function of said control system from one apparatus to another.

8. Apparatus according to claim 1 wherein said control signal is generated by touching said surface.

9. Apparatus according to claim 1 wherein said member can be removed for cleaning.

10. Apparatus according to claim 1 wherein said displayed image relates to the control panels of a plurality of apparatus having different control layouts.

11. Apparatus according to claim 1 wherein said projected image relates to the display of a device connected to said computer.

12-14. (canceled)

15. A control panel comprising
a member having a curvilinear surface on which images are displayed on at least a portion thereof
a plurality of control devices operable by a user of said control panel, said devices provided on said surface
a computer to determine the position or state of said control devices and to control the display of said images

16. Apparatus according to claim 15 further incorporating means to sense finger touch location.

17. Apparatus according to claim 15 wherein at least one of said control devices is a knob.

18. Apparatus according to claim 17 wherein said image displayed indicates the circumferential position of said knob.

19. Apparatus according to claim 17 wherein control device is a switch.

20. Apparatus according to claim 19 wherein said switch operates without contacting a users finger.

21. Apparatus according to claim 15 including programmable tactile feedback means.

22. Apparatus according to claim 15 wherein displayed labels relating to at least one of said control devices are changed in order to change from controlling one apparatus to another.
